(19) United States
(12) Patent Application Publication
(10) Pub. No.: US 2026/0083092 A1
(43) Pub. Date: Mar. 26, 2026

(54) COMPUTER-IMPLEMENTED TOOL FOR UNBIASED EVALUATION OF DETECTION PERFORMANCE

(71) Applicant: The Government of the United States of America, as represented by the Secretary of Homeland Security, Washington, DC (US)

(72) Inventors: Guy Hartsough, Bel Air, MD (US); David Newton, Sarasota, FL (US); Nicholas Knebel, Dublin, OH (US); Kyle Hofacre, Dublin, OH (US); Kevin Good, Columbus, OH (US)

(73) Assignee: The Government of the United States of America, as represented by the Secretary of Homeland Security, Washington, DC (US)

(21) Appl. No.: 19/330,232

(22) Filed: Sep. 16, 2025

Related U.S. Application Data
(60) Provisional application No. 63/697,182, filed on Sep. 20, 2024.

(51) Int. Cl. A01K 15/02

(52) U.S. Cl. CPC A01K 15/0207

(57) ABSTRACT

An aspect is directed to a method for building a canine detection exercise to evaluate detection performance of detecting targets by canine teams each including a dog and a handler. The method includes receiving an exercise design and design parameters for generating at least one of a scent lineup or a detection scenario of the canine detection exercise; and generating at least one scent lineup or at least one detection scenario of the canine detection exercise based on the design parameters. The canine detection exercise has at least one of a randomized scent lineup or a randomized detection scenario in which one or more design parameters are random number generator sampled parameters to generate the at least one of the randomized scent lineup or the randomized detection scenario.

### CROSS-REFERENCE TO RELATED APPLICATIONS

The application claims the benefit of priority from and is a non-provisional of U.S. Provisional Patent Application No. 63/697,182 , filed on Sep. 20, 2024, entitled COMPUTER-IMPLEMENTED TOOL FOR UNBIASED EVALUATION OF DETECTION PERFORMANCE, the disclosure of which is incorporated by reference in its entirety.

### SUMMARY STATEMENT OF GOVERNMENT INTEREST

The present invention was made with support from the United States Department of Homeland Security (DHS) and by an employee of DHS in the performance of their official duties. The U.S. Government has certain rights in this invention.

### FIELD

The discussion below relates generally to evaluation tools and, more particularly, to computer-implemented methods and systems for unbiased evaluation of detection performance.

### BACKGROUND

Every year, thousands of search teams at the Federal, states, and local levels of law enforcement take part in evaluations to ensure they are continuing to perform at the high level of proficiency required by each agency. Setting up detection scenarios can be very time consuming and has the potential for human bias, and records can be challenging to maintain and access for subsequent evaluations.

### SUMMARY

Embodiments of the present invention are directed to providing a tool that simplifies test scenario design and removes human bias, and logging proficiency evaluation results. An object is to achieve significant time savings and improved record-keeping. In the example of canine training and evaluation, a simple and streamlined method of conducting team evaluations gives agencies the ability to objectively carry out evaluations with consistency across canine teams.

One result is a purpose-built application to enable convenient, electronic logging of detection canine evaluation/training activities and outcomes. The resulting app provides a means for detection canine programs to efficiently create comprehensive records, complete with corroborating videos. With fully digital records, practices and performance can be easily reported, aggregated, and analyzed in the pursuit of optimally prepared teams. Further, because evaluation/training design can be a time-consuming task, and because human-designed exercises can be marred by inadvertent bias or predictability, the evaluation software is equipped with optional functionality to auto-recommend exercise designs.

In one aspect, a custom-built evaluation software tool creates and provides training evaluators with software-designed scenarios, leading to improved efficiency and reducing potential human bias in testing. It may be a tablet-based software tool. The tool can be customized to different organization and different target odors or contraband. It may include two modules for controlled validation lineups and operational scenarios with mirrored functionality. Electronic documentation of the set up provides archive capability. Electronic capture of outcomes, completed with integrated video, improves efficiency of operations and provides more comprehensive records. The design lends itself to powerful and immediate data aggregation, which leads to improved analysis and oversight.

An aspect of the invention is directed to a method for building a canine detection exercise to evaluate detection performance of detecting targets by canine teams each including a dog and a handler. The method comprises receiving an exercise design and design parameters for generating at least one of a scent lineup or a detection scenario of the canine detection exercise; and generating at least one scent lineup or at least one detection scenario of the canine detection exercise based on the design parameters. The canine detection exercise has at least one of a randomized scent lineup or a randomized detection scenario in which one or more design parameters are random number generator sampled parameters to generate the at least one of the randomized scent lineup or the randomized detection scenario.

In some embodiments, generating the at least one scent lineup comprises generating a randomized scent lineup. The design parameters which can be random number generator sampled for the randomized scent lineup include a target probability of a target, a number of targets, a number of distracters, a number of controls, the targets, and a planned set duration.

In specific embodiments, generating the randomized scent lineup comprises one or more of: sampling a number of spots in the randomized scent lineup to be generated; sampling the number of targets if at least one of the targets is present in the randomized scent lineup; sampling the number of distracters; sampling the number of controls; if a total number of items, which equals a sum of the number of targets, the number of distracters, and the number of controls, exceeds the number of spots, decreasing a sampled value of the number of spots while obeying a preset minimum value of the number of spots until the number of spots is down to a value which is at or below the total number of items; sampling the items, which comprises the targets, the distracters, and the controls, from the exercise design and shuffling an order of the items; or sampling the planned set duration. The sampled value of the number of spots may be decreased in an order of controls, distracters, and targets.

In some embodiments, the method comprises generating multiple scent lineups including one or more manually set target-free scent lineups, and further comprises sampling the target probability.

In specific embodiments, generating the at least one detection scenario comprises generating a randomized detection scenario. The design parameters which can be random number generator sampled for a randomized detection scenario include a target probability of a target, a number of the targets, a number of distracters, a number of controls, the targets, a planned set duration, a search area, an item hide location of an item of a plurality of items from a weighted list of location weights, an item hide height of the item, and an item hide depth of the item. The plurality of items comprise the targets, the distracters, and the controls.

In some embodiments, generating the randomized detection scenario comprises one or more of: sampling the number of targets in the randomized detection scenario to be generated if at least one of the targets is present in the randomized detection scenario; sampling the number of distracters; sampling the number of controls; sampling the search area for the randomized detection scenario; sampling the planned set duration; sampling the plurality of items, which comprise the targets, the distracters, and the controls, from the exercise design and shuffling an order of the items; or sampling the item hide location of each of the items from the weighted list of location weights until all the items from the weighted list of location weights have their item hide locations sampled. The method may further comprise sampling the item hide height and the item hide depth of each of the items until all the items from the weighted list of location weights have their item hide locations sampled.

In specific embodiments, the method comprises generating multiple detection scenarios including one or more manually set target-free detection scenarios, and further comprises sampling the target probability.

Another aspect is directed to a non-transitory computer-readable recording medium storing a program including instructions that cause a processor to execute a process for building a canine detection exercise to evaluate detection performance of detecting targets by canine teams each including a dog and a handler. The process comprises receiving an exercise design and design parameters for generating at least one of a scent lineup or a detection scenario of the canine detection exercise; and generating at least one scent lineup or at least one detection scenario of the canine detection exercise based on the design parameters. The canine detection exercise has at least one of a randomized scent lineup or a randomized detection scenario in which one or more design parameters are random number generator sampled parameters to generate the at least one of the randomized scent lineup or the randomized detection scenario.

Yet another aspect is directed to a method of evaluating detection performance of detecting targets in a canine detection exercise by canine teams each including a dog and a handler. The method comprises: generating at least one scent lineup or at least one detection scenario of the canine detection exercise based on design parameters of an exercise design, the canine detection exercise having at least one of a randomized scent lineup or a randomized detection scenario in which one or more design parameters are random number generator sampled parameters to generate the at least one of the randomized scent lineup or the randomized detection scenario; listing the at least one scent lineup or at least one detection scenario of the canine detection exercise for the canine teams to perform detection of the targets according to the at least one scent lineup or at least one detection scenario of the canine detection exercise; recording performance results of the canine detection exercise by the canine teams; and storing the performance results without human manipulation and without human interference of the performance results.

Other features and aspects of various examples and embodiments will become apparent to those of ordinary skill in the art from the following detailed description which discloses, in conjunction with the accompanying drawings, examples that explain features in accordance with embodiments. This summary is not intended to identify key or essential features, nor is it intended to limit the scope of the invention, which is defined solely by the claims.

### BRIEF DESCRIPTION OF THE DRAWINGS

The attached drawings help explain the embodiments described below.

FIG. 1 shows an example of a Home Page.

FIG. 2 shows an example of an App Configuration Page.

FIG. 3 shows an example of App Configuration Options.

FIG. 4 shows an example of an Add Base Materials page.

FIG. 5 shows an example of an Add Material Details page.

FIG. 6 shows an example of an Add Specific Aid page.

FIG. 7 shows an example of an Add Search Area page.

FIG. 8 shows an example of an Add Search Area Details page.

FIG. 9 shows an example of a Target Scoring page for providing primary and secondary scoring details.

FIG. 10 shows an example of a Demographics page for canine.

FIG. 11 shows an example of a Canines & Handlers page.

FIG. 12 shows an example of a Create Logbook page. From the Home page, one may select the Create Logbook box.

FIG. 13 shows an example of a Home page with Logbooks.

FIG. 14 shows an example of a Workbench (Items) page.

FIG. 15 shows an example of an Add Item Back to the Workbench page for Items and Targets.

FIG. 16 shows an example of a Workbench (Lineups) page.

FIG. 17 shows an example of a Workbench (Scenarios) page.

FIG. 18 shows an Example Lineups page according to an embodiment.

FIG. 19 shows an example of an Edit Lineup Details page.

FIG. 20 shows an example of a Choose Item in Lineup page.

FIG. 21 shows an example of an Item Details (Lineups) page.

FIG. 22 shows an example of an Edit Scenario Details page.

FIG. 23 shows an example of a Record Results page.

FIG. 24 shows an example of an Add New Teams page.

FIG. 25 shows an example of a Generate Run Order page with number added to team tile.

FIG. 26 shows an example of an Export Microsoft Excel Data Sheets page.

FIG. 27 shows an example of a Results Entry page.

FIG. 28 shows an example of a Summary of Results Under Team Name page.

FIG. 29 shows an example of an Edit Score Time page.

FIG. 30 shows an Example of a Menu Under Team Name page.

FIG. 31 shows an example of a Create Results Summary Report page.

FIG. 32 shows an example of an Analytics page for item type and table.

FIG. 33 shows an example of a Data Management page.

FIGS. 34A and 34B show a Table that lists the possible device-dependent data consumption options and examples.

FIG. 35 shows a Table listing the methods offered by the Random class used by the evaluation software to generate random numbers and how they are used.

FIG. 36 is a flow diagram illustrating an example of using a RNG for auto-generating lineups in the evaluation software.

FIG. 37 is a flow diagram illustrating an example of using a RNG for auto-generating scenarios in the evaluation software.

FIG. 38 illustrates a computing system including logic according to an embodiment.

### DETAILED DESCRIPTION

A number of examples or embodiments of the present invention are described, and it should be appreciated that the present invention provides many applicable inventive concepts that can be embodied in a variety of ways. The embodiments discussed herein are merely illustrative of ways to make and use the invention and are not intended to limit the scope of the invention. Rather, as will be appreciated by one of skill in the art, the teachings and disclosures herein can be combined or rearranged with other portions of this disclosure along with the knowledge of one of ordinary skill in the art.

Embodiments of the invention are directed to a computer-implemented tool for unbiased evaluation of detection performance. The tool provides a simple and streamlined method of conducting team evaluations that is objective and consistent across the teams. In one example, an evaluation software such as an app provides a means for detection canine programs to efficiently create comprehensive records, complete with corroborating videos. With fully digital records, practices and performance can be easily reported, aggregated, and analyzed in the pursuit of optimally prepared teams. Further, because evaluation/training design can be a time-consuming task, and because human-designed exercises can be marred by inadvertent bias or predictability, the evaluation software is equipped with optional functionality to auto-recommend exercise designs.

While the evaluation software is designed with tablets in mind, it can also be installed on laptops and desktop computers. In embodiments, it is written in C#/XAML for the user interface and business logic. The backend service and data layers are written in C# as well and utilizes an Entity Framework to interact with an SQLite database that stores the application data. Key elements/actions include configuration of the evaluation software to the specific mission and contraband of the employing entity, exercise design and documentation, exercise outcome/result entry, database archiving and management, and results aggregation. Logbooks are the primary organizational structure within the evaluation software, created by the user as needed to organize and catalog different training/testing activities. Within each logbook, the user can modify the Workbench to reflect their current objective and/or available resources, and then can either manually design specific exercises or allow the evaluation software to auto-generate them within set bounds. Results, observations, and video are recorded via an interactive interface. Analytics functionality allows users to create tailored data aggregations and views. Data management controls are provided to perform key administrative actions and facilitate database synchronization among devices.

Quality Assurance (QA) was performed to ensure the stability, efficiency, and accuracy of the evaluation software. These efforts spanned Development Testing, User Acceptance Testing, and Regression Testing. Development Testing consisted of writing and executing unit tests, peer reviews of the code, and developer QA of new features and bug fixes. User Acceptance Testing involved staff knowledgeable of the intended functionality using the evaluation software in a manner that was realistic for operations. Finally, Regression Testing included a suite of nearly 250 procedure-based tests documented to confirm working functionality of core features and performance/load-based testing to gauge the user experience with varying amounts of application data records.

### 1. Introduction

Daily, thousands of federal, state, and local government detection canine teams conduct training to keep their skills sharp and U.S. citizens safe. These efforts typically culminate in an annual evaluation to formally confirm that individual team performance meets department standards. Within this training and testing lies record-keeping challenges, but also opportunity for data and insight that can improve handler education, training tactics/focus, and program oversight. A purpose-built application provides convenient, electronic logging of canine detection exercise details (hidden substances, hide locations, placement times, etc.) and subsequent outcomes (detections, false positives, etc.). The result is an ability for our nation's canine programs to efficiently create comprehensive records, complete with corroborating videos. With fully digital records, practices and performance can be easily reported, reviewed, aggregated, and analyzed by handlers, trainers, and leadership in their quest for optimally prepared detection canine teams. Further, because evaluation/training design can be a time-consuming task, and because human-designed exercises can be marred by inadvertent bias or predictability (or even the perception of bias), the evaluation software is additionally equipped with optional functionality to auto-recommend exercise designs, complete with training aid type, hide location, set duration, etc.

Specific features and benefits of the evaluation software include: efficient comprehensive electronic logs, complete with integrated video records; efficient and improved scenario planning efforts through organization-specific customizations and/or the optional auto-generate functionality; assistance in tracking hides in complex environments through image capture and notes; and efficient and insightful in-tool data review, aggregation, and analyses. A small sampling of examples of the in-tool data aggregation and analyses includes instantly tallying the number of training exposures achieved in the last 3 months on a challenging training aid material, and easily comparing the training usage of specific hide locations within a given search environment (e.g., number of engine compartment-based hides vs. number of trunk-based hides).

### 2. Software Overview

The following is a high-level introductory overview of key elements/functions of the evaluation software.

### 2.1. Home Page

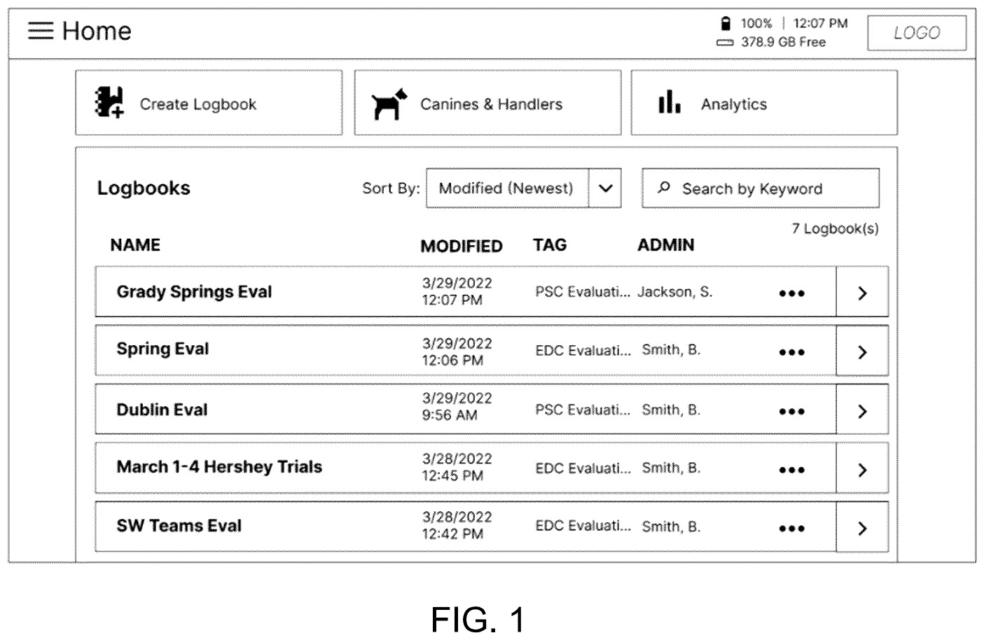

FIG. 1 shows an example of a Home Page. When the evaluation software is launched, it opens to the Home Page. Here, all the logbooks existing on that device are listed for easy access; using the provided controls, this list is sortable and searchable. Also, the three tabs across the top of the page provide quick access to key areas: Create Logbook, Canines & Handlers, and Analytics. Finally, the Main Menu is accessed via the three horizontal lines in the top left corner; this Main Menu is accessible in most areas of the app and allows users to navigate directly to key pages and functions.

After installation, the evaluation software is configured to be customized to reflect the user's specific organization. This process represents the first area of focus/effort and is completed before the app can be used, but when performed properly, should rarely need further editing. Under App Configuration or Software Configuration, the user may:

Input the items (targets, distracters, controls) to be used in training/testing (Section 2.2.1).

Define the commonly used search areas and hide locations (Section 2.2.2).

Customize the scoring options (Section 2.2.3).

List canine and handler demographics to be recorded (Section 2.2.4).

Additionally, the individual canines and handlers will also need to be input into the app (Section 2.3).

### 2.2. Software Configuration

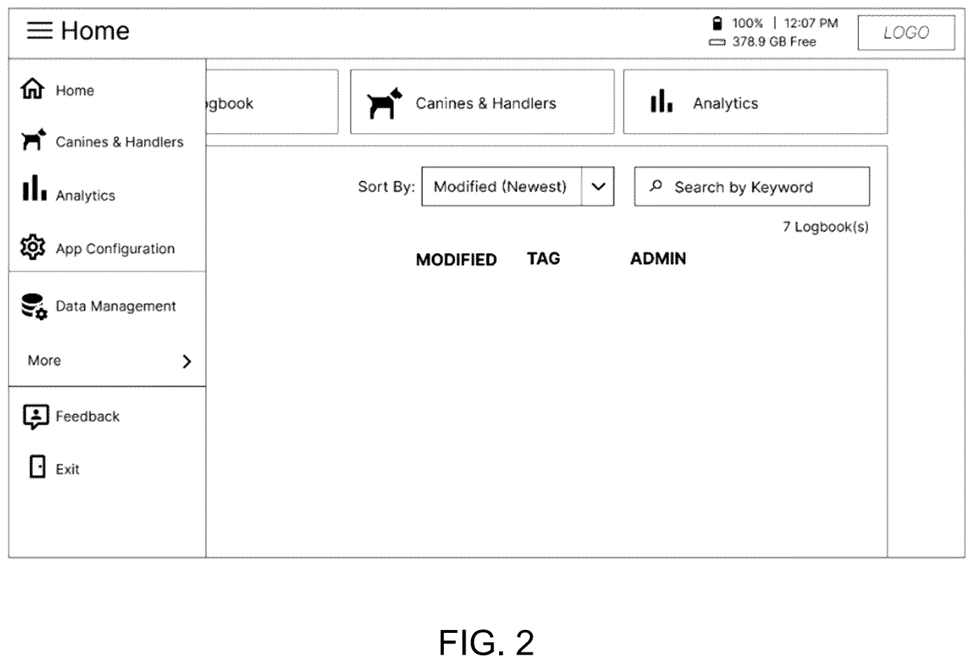

FIG. 2 shows an example of an App Configuration Page. Accessible via the Main Menu (e.g., by tapping on the Main Menu icon and selecting App Configuration), the Software Configuration or App Configuration pages are where the evaluation software is tailored to reflect the user's specific organization by defining their targets/training aids, applicable search areas, viable hide locations, and preferred scoring options. This configuring of the app represents the first area of focus/effort after the evaluation software is installed and is completed before the app can be used. When set up properly, however, the App Configuration should rarely need further editing.

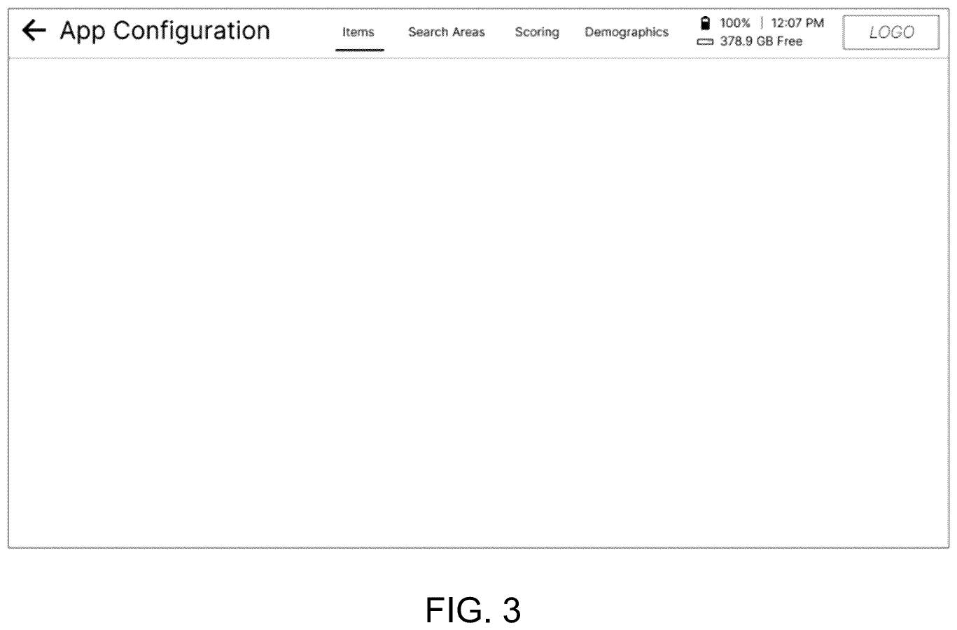

FIG. 3 shows an example of App Configuration Options. The App Configuration page may have subsections for inputting/defining Items, Search Areas, Scoring, and Demographics. This information builds an inventory from which the user will later select on the Workbench (Section 2.4.1) and Build Exercises (Section 2.4.2) pages.

### 2.2.1. Define Items

Items can be input by selecting, for instance, an Items tab from the top of the App Configuration page. In one example, Targets, Distracters, Controls, or Barriers can be specified by selecting each button from the App Configuration page.

When conducting canine detection exercises, especially for training or testing, it is crucial to implement controls to ensure the dog is genuinely detecting the target odor and not responding to other factors. Controls are items or odors that are intentionally placed during training to help the dog differentiate between the target odor and the other potential stimuli. They are distinct from distracters, which are random, novel items introduced to assess focus. Controls help the dog understand what the target scent is, while distracters help ensure the dog is not simply reacting to environmental cues or handler influence. Here are some key controls to consider:
1. Non-Targets and Distractors: Intentionally placed non-targets (controls) are items or odors the dog might accidentally associate with the target, such as the training aid packaging or handling gloves. The purpose is to clearly communicate the specific target odor to the canine, ensuring they are not just reacting to the packaging or preparation process. Distractors are random, ever-changing novel items in the environment used to ensure the dog is not simply responding to anomalous odors placed by a familiar person. A best practice may be to include a ratio of five non-targets for every one target to help prevent the dog from associating activity-related odors or indicators with the target. This also ensures the dog remains focused on the true objective: target odor.
2. Minimizing Handler and Observer Bias: Blinding such as single-blind testing (handler unaware of target location) is common, but double-blind testing (neither handler nor observer knows the target location) is the gold standard for minimizing bias. The purpose is to prevent intentional or unintentional cueing by the handler or observer, such as changes in pace, body language, or even holding their breath near the target. Strategies include, for example, positioning handlers and observers so the dog cannot see them, using well-defined testing protocols and assess both dog and handler performance separately, randomizing target placement to avoid the dog learning patterns, and using automated systems for data collection when possible to reduce subjectivity.
3. Odor Sample Controls: Positive controls are used to ensure the dog is responding to the target odor and not to contamination or extraneous cues. The purpose is to validate that dogs are capable of responding to the odor they were trained to detect. Implementation may involve using new or refreshed samples, samples from different sources, and ensure proper handling and storage to avoid contamination. Negative controls (Distractors) are non-target odors used to ensure dogs discriminate the target odor from other smells. The purpose is to prevent false alerts and ensure the dog is specifically alerting to the target odor. Implementation may involve including odors similar in intensity to the target, and odors commonly associated with training, the training environment, and the target container.
4. Criteria Testing: Before testing, dogs should meet pre-determined performance criteria, such as a minimum hit rate and maximum false alarm rate, to ensure they are prepared for the assessment. The purpose is to provide a baseline measure of performance and ensure the dog is proficient in detecting the target odor.
5. Environmental Factors: Consider temperature, humidity, airflow, terrain, and distractions. Implementation may involve conducting training and testing in a variety of environments to ensure the dog can perform effectively in different conditions.

By implementing these controls, canine detection exercises can be made more reliable and the results more valid, ensuring the dog is effectively and accurately performing its intended task.

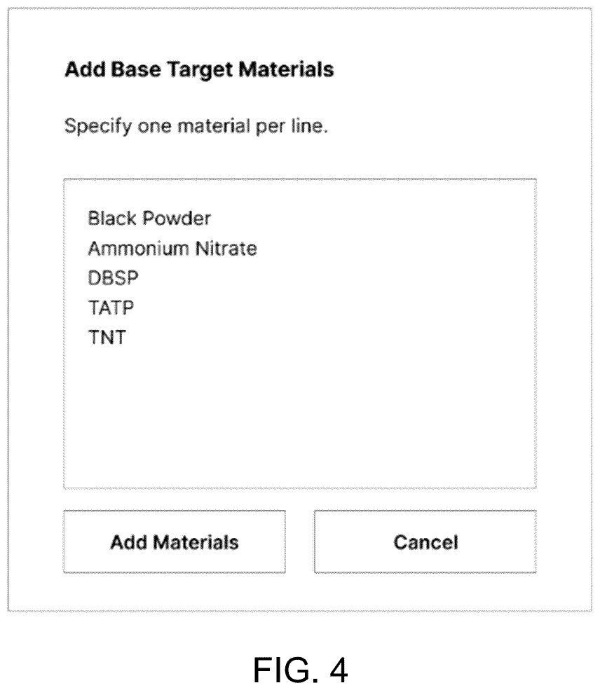

FIG. 4 shows an example of an Add Base Materials page. On the Targets page, under the heading Step 1, general target materials can be input by selecting +Add Base Materials. General names of materials should be added into the box, one per line, as seen in FIG. 4. One may select Add Materials to save the list and return to the Targets page. Additional materials can be added later by repeating this process.

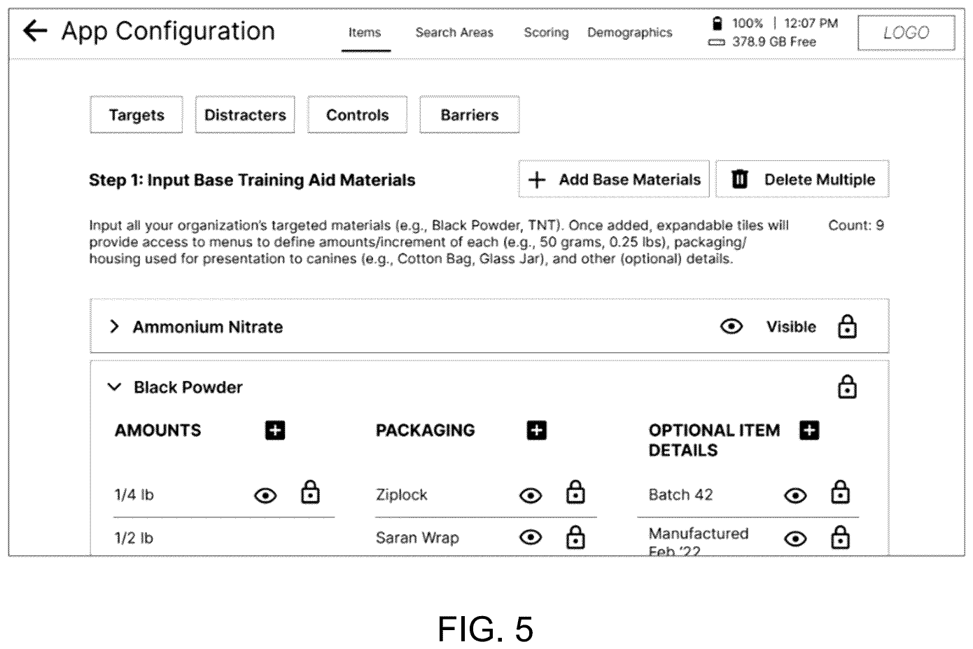

FIG. 5 shows an example of an Add Material Details page. Once saved, amounts, packaging, and optional item details can be added to each target material by selecting the Caret icon next to the target name. This action expands the box to include the input menus for each detail type. FIG. 5 illustrates the list of targets, with and without details.

Details can be added by selecting the Plus icon and typing one new option per line and saving (Save) when complete. To shorten data entry, once details have been entered and saved for one material (e.g., amounts, packaging, or item details for Black Powder), these same details can be applied to other materials (e.g., Ammonium Nitrate). One may select the Plus icon in the new material, then the Import From button, and finally, the original material name from the drop-down menu (e.g., Black Powder). Once selected, the list of details will automatically be populated into the dialog box and can be edited before saving (Save). This action can be repeated as many times as necessary to enter all the possible amounts, packaging, and item details for each material. One may use the Sort icon to edit the display order of the item details and use the Eye icon to make an item visible or hidden in subsequent menus/areas.

The Delete Multiple button can be used to delete base materials from the list of targets. Once the button is selected, one may check the box of the materials that are to be deleted, then select Confirm Delete. To leave the delete mode without making changes, one may select the Exit Delete Mode button.

Next, under the heading Step 2, the user generates a list of the actual, detailed targets physically available for use in future exercise building and data recording. This list can be auto-generated from all of the possible combinations of Material, Amount, and Packaging by selecting the Auto-Generate button within the expanded box of each material. Alternately, one may add detailed targets.

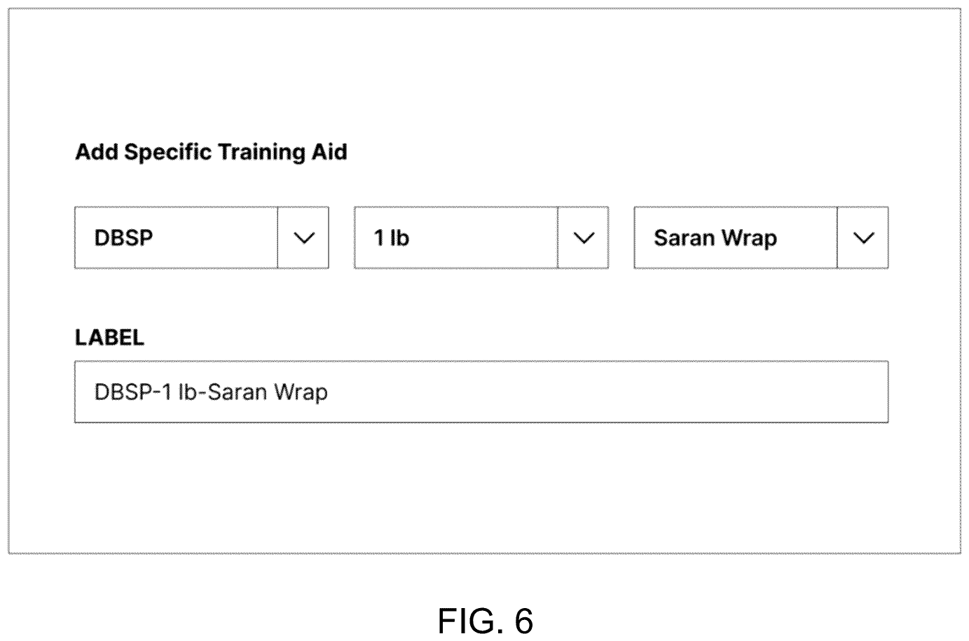

FIG. 6 shows an example of an Add Specific Aid page. Detailed targets can be added individually by selecting the Add Specific Aid button, which brings up the dialog box shown in FIG. 6. Drop-down menus are used to specify the Material, Amount, and Packaging. A unique label for this combination can be typed into the box; otherwise, a label is generated listing the Material, Amount, and Packing by default when Add is selected. The steps in this section should be repeated to add Distracters and Controls.

Barriers can also be added via the Barriers page by tapping +Add Barrier Materials. These materials, often used in conjunction with targets to avoid cross-contamination of the aid/environment, are simply input by adding the barrier material name and do not require the user to specify amounts or packaging. Although commonly used as controls, items entered as Barriers are not automatically available as control items. If a barrier material will be used as a control item in exercises, these materials are also to be entered under Controls.

### 2.2.2. Define Search Areas

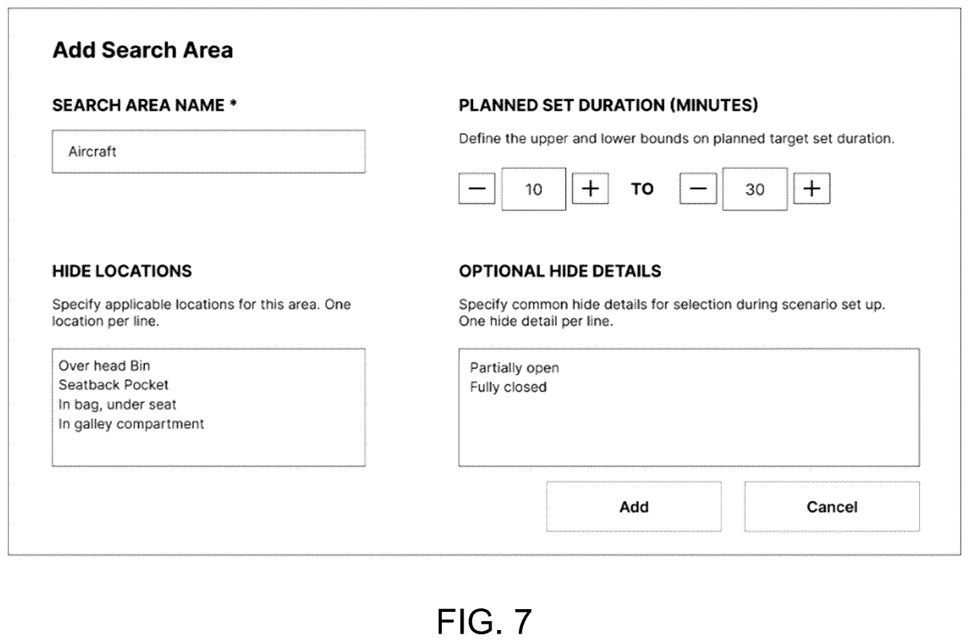

FIG. 7 shows an example of an Add Search Area page. Search areas can be input by selecting the Search Areas tab from the top of the App Configuration page and then the button +Add Search Area. This action will open a dialog box of FIG. 7 in which details about the area, such as hide locations and the set duration, can be entered, and then saved (Add).

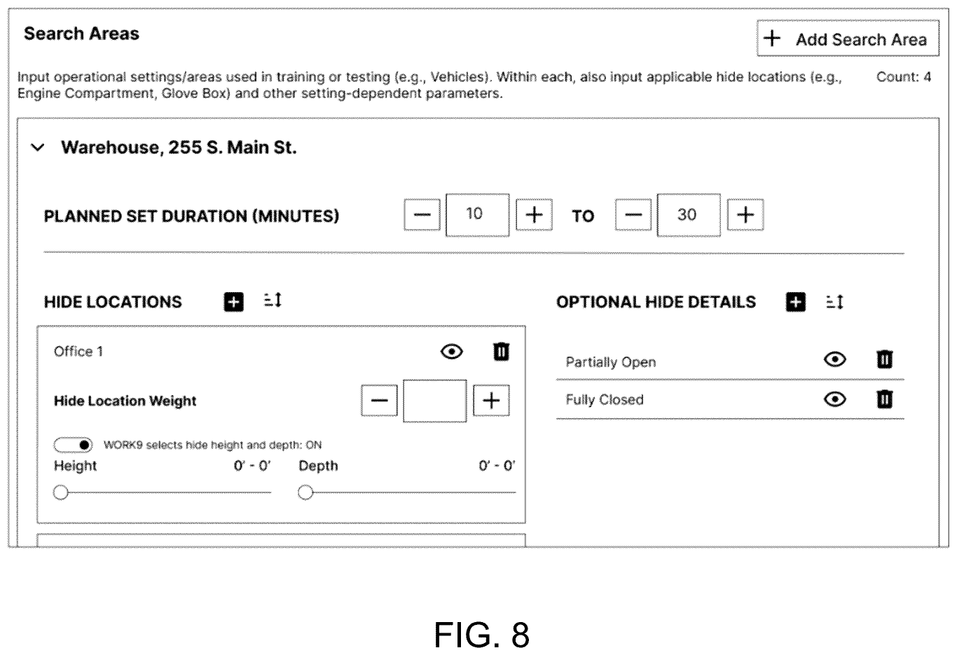

FIG. 8 shows an example of an Add Search Area Details page. Once a search area has been added, additional location details can be input by selecting the Caret icon next to the search area name. Details that can be input may include:

Planned Set Duration. The minimum and maximum set duration (in minutes) for items placed in this search area can be specified by pressing the − and + buttons. The evaluation software will assign items a set duration within this range when generating scenarios. Set duration can also be set when manually designing an exercise. The duration of a planned set varies depending on a number of factors and the type of the planned set such as training sessions, operational scenarios, search and rescue, and real-world searches. Factors influencing search duration include, for instance, environmental conditions, terrain, target odor availability and volatility, handler and dog characteristics, effective sweep width, search strategy, and dog and handler fatigue/motivation. In sum, the duration will depend on the specific training goals, environmental conditions, and the capabilities of the dog and handler team.

Hide Locations. Hide locations can be added and the display order sorted. Two additional details, within each hide location, can be specified, including Hidden Location Weight and a toggle button. Hide Location Weight can be varied by pressing the − and + buttons to change how often this location is selected by the evaluation software in comparison to the other hide locations within this search area. For example, if the Hide Location Weight for Seat Back Pocket is set to 3, Overhead Bin to 2, and Lavatory to 1, then the evaluation software will propose hiding an item in a seat back pocket 50% of the time (weight 3 out of a total of 6). The toggle button can be selected to turn on/off whether the evaluation software dictates the hide height and depth in the generated scenarios. If selected ON, minimum and maximum heights and depths (0 to 10 ft) can be input by adjusting the bars to the desired ranges. If selected OFF, heights and depths of hides will not be specified by the evaluation software but can be recorded later (see Section 2.4.2.2).

Optional Hide Details. Additional details on hides (e.g., partially open, closed) can be added or sorted and are available for selection when creating scenarios.

### 2.2.3. Define Scoring

Scoring terminology can be defined by selecting the Scoring tab from the top of the App Configuration page. The purpose of this page is to customize the labels with the preferred terminology of the user, which will later be displayed during data collection on the app's Record Results page.

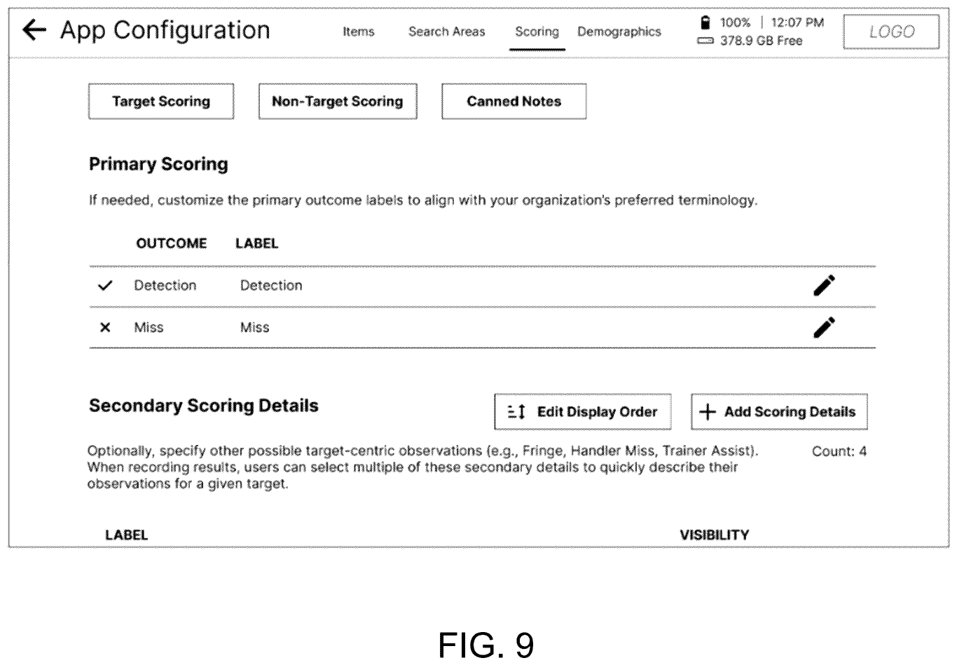

FIG. 9 shows an example of a Target Scoring page for providing primary and secondary scoring details. Specific terminology can be entered for Target Scoring, Non-Target Scoring, and Canned Notes by selecting those buttons along the top of the Scoring page.

Primary scoring outcomes are set, while labels for those outcomes can be modified to match user preference by tapping on the Pencil icon, entering the new label into the dialog box, and saving (Save). For instance, a user may prefer to record a canine correctly identifying a target as a “Find” rather than a “Detection” to align with department preferred terminology. Secondary scoring details can be added by selecting +Add Scoring Details and entering one detail per line via the resulting dialog box. These details (e.g., canine aggressed, handler induced) will be available during data collection in the order listed on the Target Scoring page. Primary/secondary scoring details specific to targets and non-targets should be entered on their respective pages, and multiple details can be selected during data collection to adequately record any observations.

Canned Notes are additional general observations (e.g., poor leash control, search speed is too fast) that should be entered at this stage of setup so that they are available for rapid logging while recording results. The order of the list on these pages (modified by selecting Edit Display Order) and whether the details are tagged as Visible is reflected in later menus in the app. Once labels have been part of a database packaging/archiving event (Section 2.6.6.1), they cannot be edited and will display the Locked icon.

### 2.2.4. Define Demographics

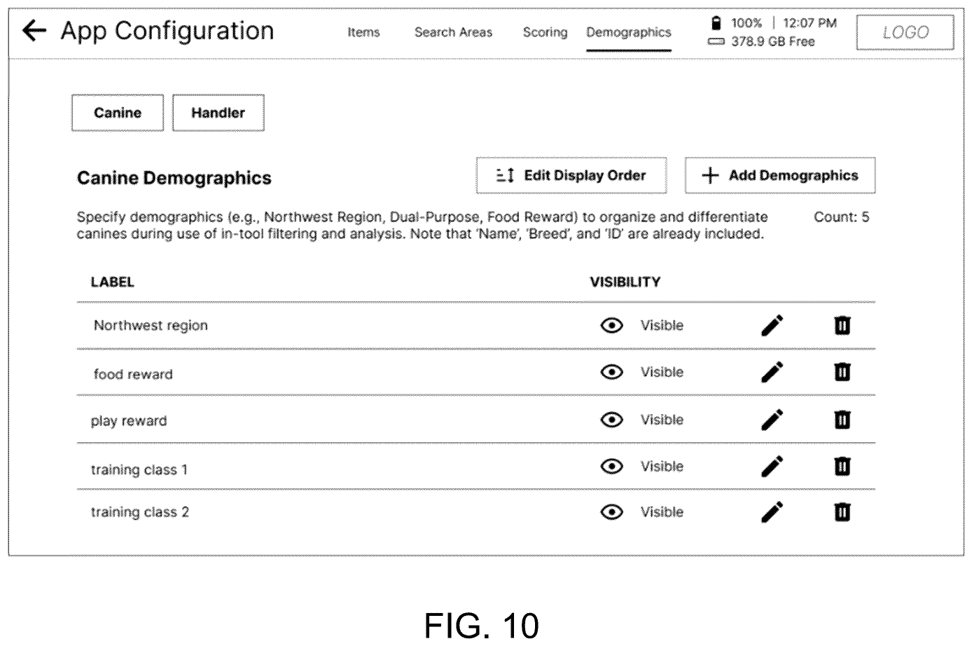

FIG. 10 shows an example of a Demographics page for canine. Demographics can be input for canines or handlers by selecting the Demographics tab from the top of the App Configuration page. The purpose of the Demographics page is to specify demographics to organize and differentiate canines and handlers during the use of in-tool filtering and analysis. The evaluation software can filter and display performance results from canines that are, for example, food reward or dual purpose, if those categories were entered into the Demographics page and tagged to a specific canine when it is entered into the evaluation software (Section 2.3). Note that this demographic classification is in addition to the canine's name, breed, and ID, or the handler's name and affiliation. Further examples of demographics are regional affiliations, reward types, breeding programs, and training classes.

One may select the Canine or Handler button at the top of the Demographics page to enter demographic categories into their respective pages. One may tap on +Add Demographics to open the dialog box, type one demographic category per line, and then tap Add Demographics to save the entries. The order of the list on these pages (modified by selecting Edit Display Order) and whether the demographic is tagged as visible (Eye icon) is reflected in later menus in the app.

### 2.3. Canines & Handlers

Accessible from the Home page or the Main Menu, the Canine & Handler pages are used to enter the names and other identifying information of the canines and handlers in the user's organization. Distinctive demographics, such as “dual purpose,” “food reward,” etc., can be created in the App Configuration and then assigned to a canine and or a handler to aid in later categorization and analysis of the performance results.

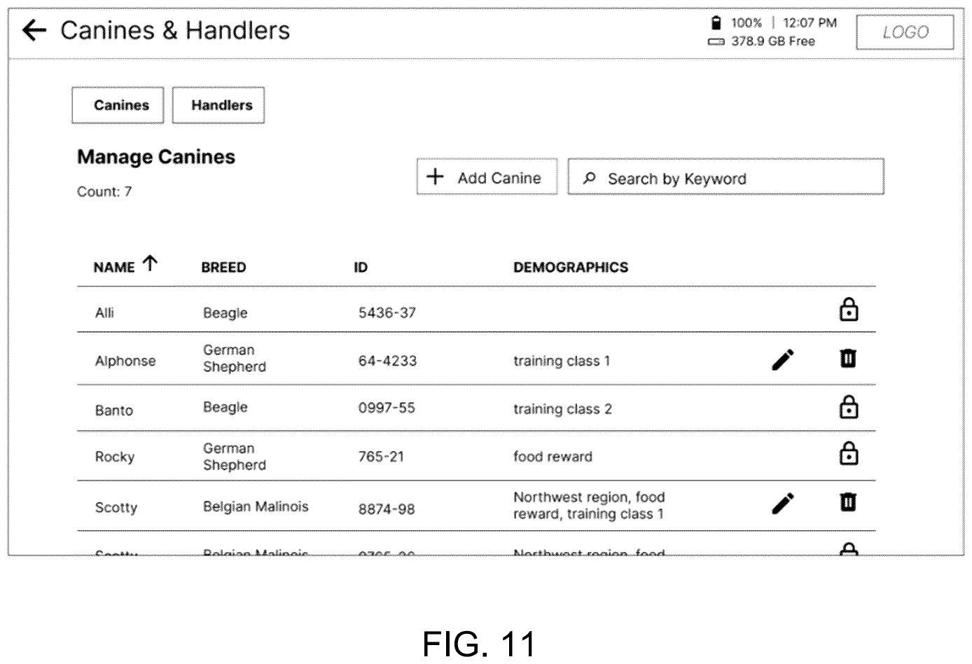

FIG. 11 shows an example of a Canines & Handlers page. The Canines & Handlers page can be accessed through the Main Menu, or by selecting the box labeled Canines & Handlers on the Home page. To enter canine information, one first selects the Canine button at the top of the Canines & Handlers page, and then presses +Add Canine to open a dialog box into which the name, breed, and ID of the dog are entered. Multiple demographic tags (see Section 2.2.4) can be attached to this dog by selecting from the Add Demographics drop-down menu. The information is saved by selecting Add and the canine is then displayed in the table on the Canine & Handlers page. The search bar in the top right portion of the page can be used to filter the list of canines by the entered keyword (i.e., a specific dog name, all of one type of breed, ID). Once several canines have been entered, the list can be displayed in order by name, breed, or ID by tapping on the column name (tap once to display in alphabetic order; tap again to display in reverse order).

Handler information can be entered by selecting the Handlers button on the Canines & Handlers page, then pressing +Add Handler. This action opens a dialog box into which the name and affiliation of the handler are entered. Multiple demographic tabs (see Section 2.2.4) can be attached to each handler by selecting from the Add Demographics drop-down menu. The information is saved by selecting Add and the handler is displayed in the table on the Canine & Handlers page. The search bar in the top right portion of the page can be used to filter the list of handlers by the entered keyword. Once several handlers have been entered, the list can be displayed in order by first name, last name, or affiliation by tapping on the column name (tap once to display in alphabetic order; tap again to display in reverse order). One may select the Left Arrow icon in the top left corner of the page to return to the Home page.

### 2.4. Logbooks

The steps taken in Section 2.4 provide the evaluation software a full inventory of items and parameters to generate exercises, namely, canine detection exercises. The steps outlined below narrow that inventory down into the specific exercises the user wants to perform that day, that week, or for a specific event.

Logbooks are the primary organizational structure within the evaluation software. Separate logbooks can be created as needed to organize and catalog different training/testing activities. Examples of logbook usage/organizational schemes include: one day of a larger certification event, an entire week-long certification event, one day of training activities, one week of training activities, or an entire six-week training course. One logbook could represent a week-long evaluation of multiple canine teams. Alternately, a logbook could be created to record the results of a full 12-week training course for a single dog. Within a logbook, the user defines workbench parameters, builds exercises, and records results, all three of which have tabs along the top of the screen to allow easy movement between these activities.

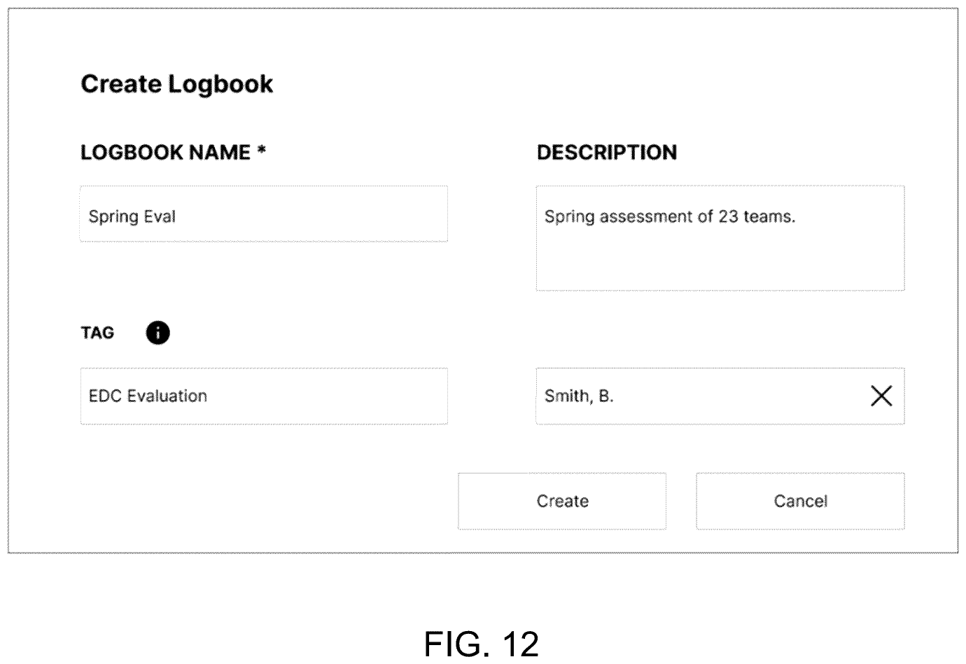

FIG. 12 shows an example of a Create Logbook page. From the Home page, one may select the Create Logbook box. A dialog box of FIG. 12 will appear, into which the Logbook Name, Description, Tag, and Admin information can be entered. All fields in this dialog box are user-defined. The Tag is used to categorize logbooks by an attribute or objective (e.g., imprinting, advanced, training, evaluation) that can later be searched. Admin is a field that allows the user to record the responsible evaluator or trainer, although a different administrative detail (e.g., date or location) can be entered, if desired. One may select Create to save the logbook information.

Once saved, the logbook is displayed on the Home page. The list of logbooks (once there are more than one) can be sorted by Name (alphabetical), Logbook Tag, Logbook Admin, Date Modified (Newest), and Date Modified (Oldest) by selecting the desired attribute from the Sort By drop-down menu on the Home page. The search bar in the top right portion of the page can be used to display a subset of logbooks filtered by the entered keyword.

Individual logbooks can be duplicated, edited, or removed by first selecting the “ . . . ” ellipsis on the line of the logbook, then the desired function. A popup will ask to confirm the action before continuing. Selecting the “ . . . ” ellipsis, then More Info will display a popup with the details entered during logbook creation. Once results have been recorded and a logbook has been packaged for data management (Section 2.6.6.1), the Locked icon will appear next to the logbook name and the logbook information can no longer be edited.

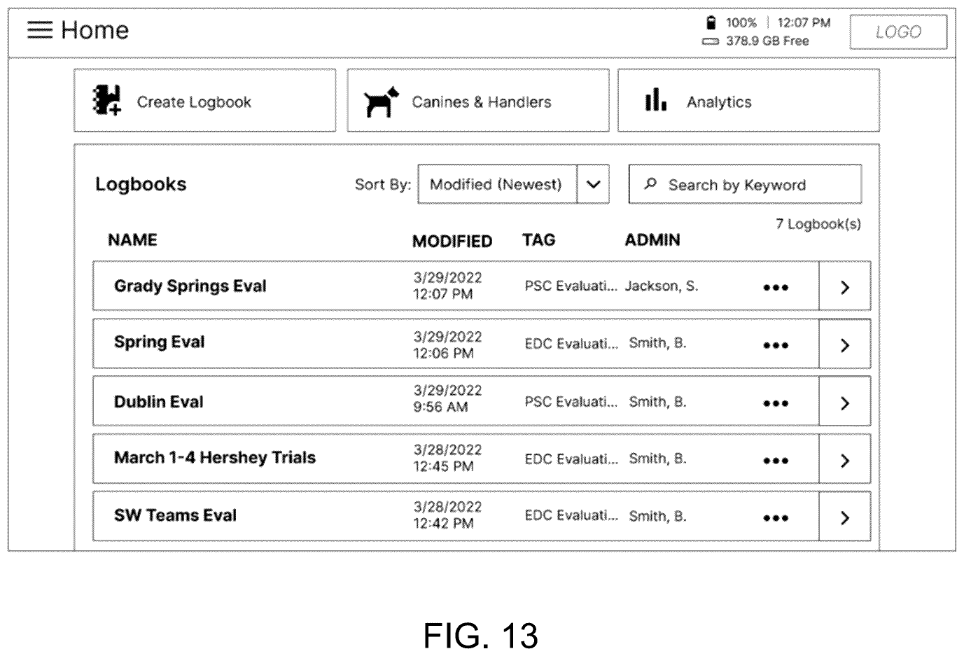

FIG. 13 shows an example of a Home page with Logbooks. One may select the Caret icon at the right end of the logbook line to proceed to creating specific scenarios/lineups.

### 2.4.1. Workbench

The steps taken under App Configuration provide the evaluation software a full inventory of items and parameters to generate exercises, namely, canine detection exercises. In the Workbench, the user adjusts the items available for use in the to-be-built exercises and the settings for auto-generated exercises. In other words, the user regularly modifies the Workbench to reflect their current objective and/or available resources. For example, they can specify the subset of targets available on that specific day, limit search areas to those of current interest, or increase/decrease the frequency a target is present in scent lineups based on maturity of the canine teams.

Once the Caret icon is selected, this action will open a page where the Workbench details can be specified—Items, Lineups, and Scenarios buttons should be selected to further define those parameters to reflect the user's current objective and/or available resources for the planned exercises. Workbench parameters can be edited at any time and changes are saved for use in future logbooks (i.e., the user does not have to define these design parameters again when a new logbook is created). Any changes to the App Configuration pages, through modifications the user makes or by consuming data packages (Section 2.6.6.2), will be reflected on the Workbench page.

### 2.4.1.1. Items

On the Record Results page, an Options drop-down exists and leads to the ability to Export Logbook Data; this option yields a Microsoft Excel file that contains two tabs, one containing all the data from the lineups in that given logbook and one containing all the data from the scenarios in that same logbook. Specifically, in this Excel file, every exposure to every item in that one logbook will exist as one row, and the columns of that row will specify the involved canine, responsible handler, placement details and times, outcome/scores, notes, and more. With this ability, users can plot, filter, and analyze the data outside of the evaluation software should they wish to do so.

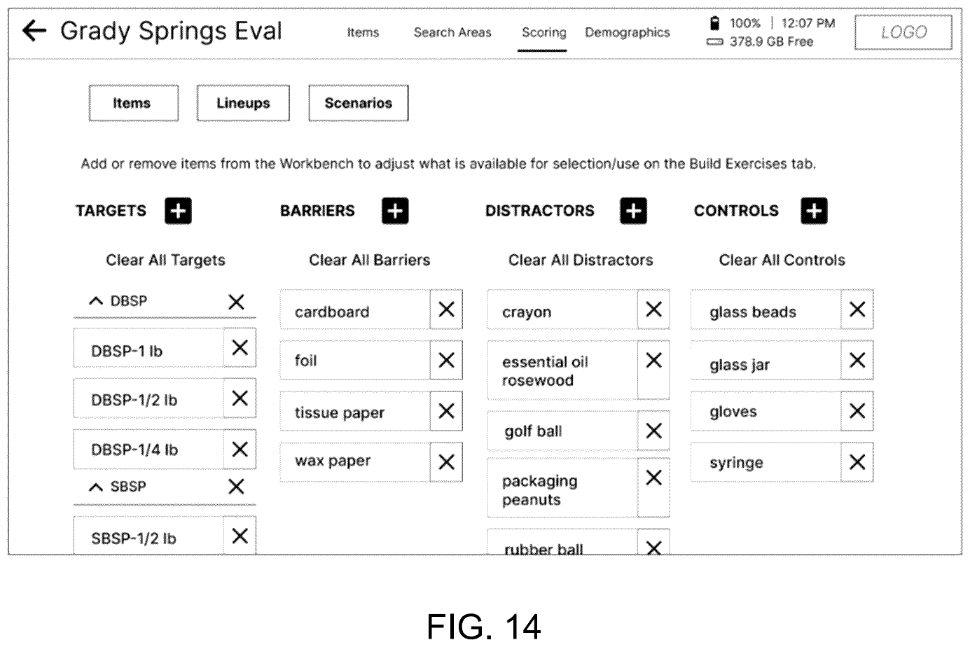

FIG. 14 shows an example of a Workbench (Items) page. With the Items button selected, the user will be shown all Targets, Barriers, Distracters, and Controls entered into the evaluation software under App Configuration. If only a subset of these items is available to the user on that specific day, or the trainer wants to focus on a small list, the user should reduce the list of items by deleting those not available/of interest. One may press the X next to each individual item, or the X next to the category header to delete all items of one type (e.g., all DBSP targets), or Clear All to delete each of the targets, barriers, distracters, or controls.

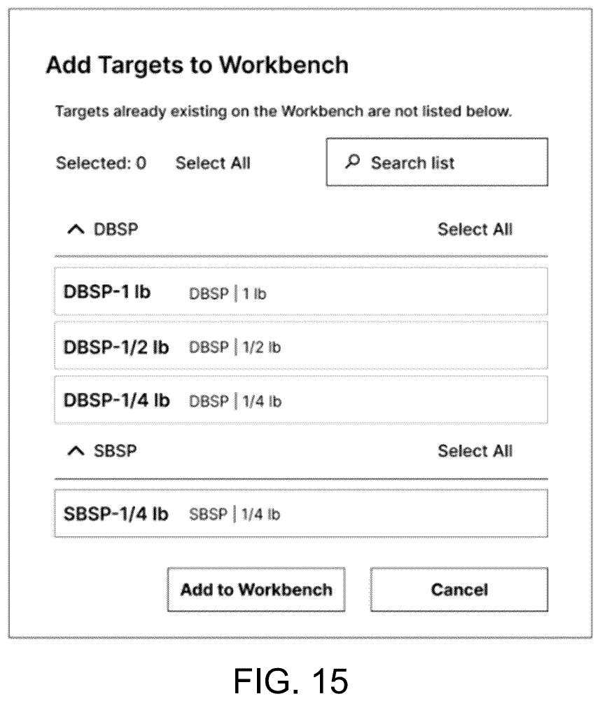

FIG. 15 shows an example of an Add Item Back to the Workbench page for Items and Targets. If any item needs to be added back into the list, one may press the Plus icon next to the item type; this action will open a dialog box with a list of all items of that type originally entered under App Configuration. The search bar can be used to locate a specific item. One may select the desired item(s) and press Add to Workbench to complete the action. (If a desired item is not listed on the Workbench page, it can be added via the App Configuration page (Section 2.2.1)).

### 2.4.1.2. Lineups

On the Record Results page, an Options drop-down exists and leads to the ability to Export Logbook Data; this option yields a Microsoft Excel file that contains two tabs, one containing all the data from the lineups in that given logbook and one containing all the data from the scenarios in that same logbook. Specifically, in this Excel file, every exposure to every item in that one logbook will exist as one row, and the columns of that row will specify the involved canine, responsible handler, placement details and times, outcome/scores, notes, and more. With this ability, users can plot, filter, and analyze the data outside of the evaluation software should they wish to do so.

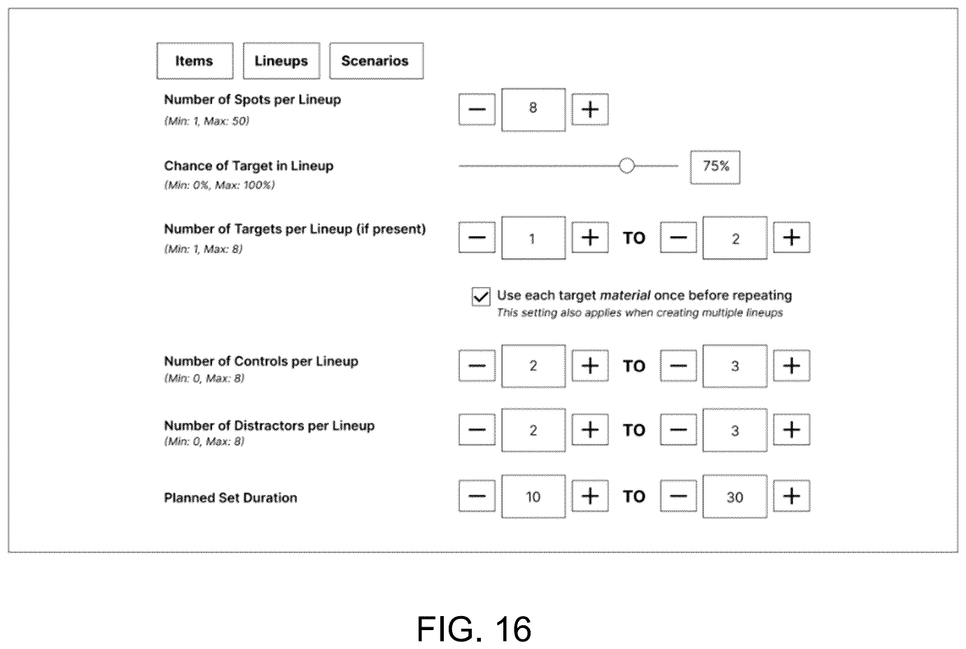

FIG. 16 shows an example of a Workbench (Lineups) page. With the Lineups button selected, the user will be shown all of the settings used to generate lineups. Values are pre-populated but can be modified; any changes are autosaved and retained as the lineup settings in newly created logbooks. Settings that can be modified for lineups are:

Number of Spots per Lineup. One may use the + and − buttons to specify how many spots (e.g., cans, boxes, bins) per lineup should be included in each generated lineup. Lineups can include 1 to 50 spots.

Chance of Target in Lineup. One may move the slider up or down (0 to 100%) to specify how often a target should be included in the generated lineups (e.g., if the slider is set to 50%, on average one out of every two lineups would contain a target item; the other lineup would not have a target item).

Number of Targets per Lineup (if present). One may use the + and − buttons to specify a range of the number of targets that will be included in a lineup (if that lineup is designated a target lineup). The minimum is 1 target, and the maximum can be set up to the total number of spots set per lineup (discussed above) such that a target can be included in every spot (e.g., if number of spots per lineup equals ten, then the maximum number of targets per lineup also equals ten). Use Each Target Material Once Before Repeating. One may check this box to force the evaluation software to use each target material available (in Workbench/Items) once before reusing any target materials.

Number of Controls per Lineup. One may use the + and − buttons to specify a range of the number of controls that will be included in each lineup. The minimum is 0 and the maximum can be set up to the total number of spots set per lineup.

Number of Distracters per Lineup. One may use the + and − buttons to specify a range of the number of distracters that will be included in each lineup. The minimum is 0 and the maximum can be set up to the total number of spots set per lineup.

Planned Set Duration. One may use the + and − buttons to specify a range for the set duration of items placed in the lineups. The minimum set duration is 0 minutes, and the maximum set duration is 1,440 minutes (24 hours).

Number of Lineups to Generate. One may use the + and − buttons to specify the number of lineups the evaluation software should generate when selecting +Auto-Generate Multiple Lineups. The minimum is 1 and the maximum is 10 lineups.

### 2.4.1.3. Scenarios

On the Record Results page, an Options drop-down exists and leads to the ability to Export Logbook Data; this option yields a Microsoft Excel file that contains two tabs, one containing all the data from the lineups in that given logbook and one containing all the data from the scenarios in that same logbook. Specifically, in this Excel file, every exposure to every item in that one logbook will exist as one row, and the columns of that row will specify the involved canine, responsible handler, placement details and times, outcome/scores, notes, and more. With this ability, users can plot, filter, and analyze the data outside of the evaluation software should they wish to do so.

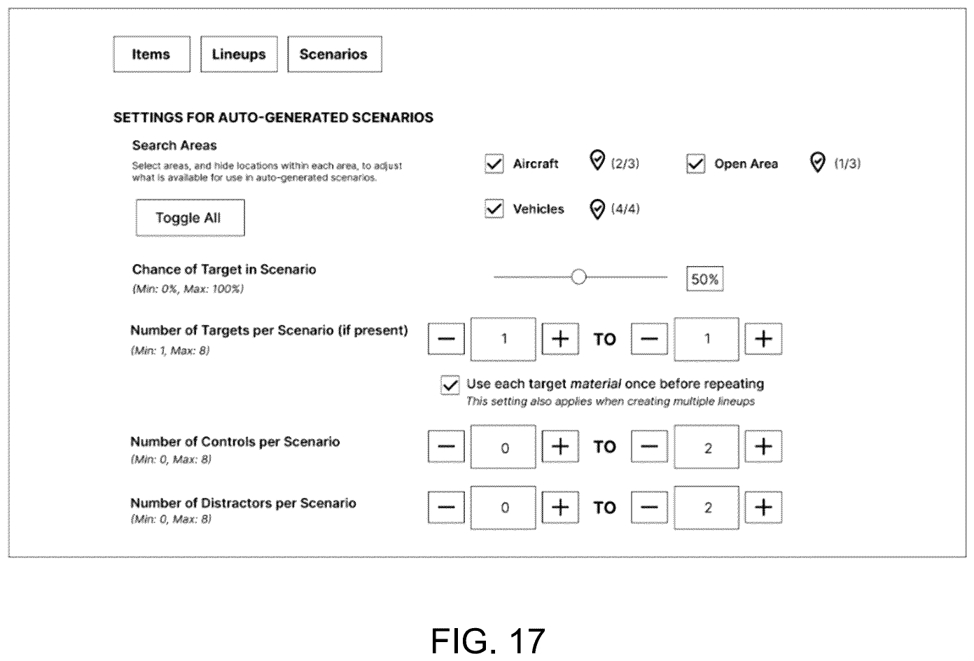

FIG. 17 shows an example of a Workbench (Scenarios) page. With the Scenarios button selected, the user will be shown all of the settings used to generate operational scenarios. Values are pre-populated but can be modified; any changes are autosaved and retained as the scenario settings in newly created logbooks. Settings that can be modified for scenarios are:

Search Areas. One may select search areas that the evaluation software should use to generate scenarios by checking the box next to the search area name. One may tap the Location icon to pull up the possible hide locations for each search area; specific hide locations can be selected/deselected by checking/unchecking the box next to the hide location name. One may use the toggle to allow multiple instances of a hide location or limit to one. One may tap the Toggle All button to change the check box to the alternate status (checked vs. unchecked) for every search area.

Chance of Target in Scenario. One may move the slider up or down (0 to 100%) to specify how often a target should be included in generated scenarios (e.g., if the slider was set to 75%, on average three out of every four scenarios would contain a target item; the other scenario would not have a target item).

Number of Targets per Scenario (if present). One may use the + and − buttons to specify a range of the number of targets that will be included in a single detection scenario (if that detection scenario is designated to contain a target). The minimum is 1 target, and the maximum is 30 targets. Use Each Target Material Once Before Repeating. One may check this box to force the evaluation software to use each target material available (in Workbench/Items) once before reusing any target materials.

Number of Controls per Scenario. One may use the + and − buttons to specify a range for the number of controls that will be included in each scenario. The minimum is 0 and the maximum is 30 controls.

Number of Distracters per Scenario. One may use the + and − buttons to specify a range for the number of distracters that will be included in each scenario. The minimum is 0 and the maximum is 30 distracters.

Number of Scenarios to Generate. One may use the + and − buttons to specify the number of scenarios the evaluation software should generate when selecting +Auto-Generate Multiple Scenarios. The minimum is 2 and the maximum is 10 scenarios. Use Each Search Area Once Before Repeating. One may check this box to force the evaluation software to use each search area specified (under Search Areas at the top of the page) once before reusing any search areas.

### 2.4.2. Build Exercises

From the Build Exercises page, the user can either manually design specific scent lineups and operational scenarios or allow the evaluation software to auto-generate randomized designs, fully detailed with training aid type, mass, set duration, and hide location. The auto-generate feature was designed to improve efficiency, and to also be a powerful tactic to reduce inadvertent human bias and predictability. Once created, tapping on a given lineup/scenario opens an expanded view, where images, set time, hide location, notes, and other fine details can be input/edited as needed to document the exercise's specifics and its set-up.

Once Workbench parameters or design parameters have been established, the evaluation software can generate specific lineups and/or operational scenarios by moving to the Build Exercises page within the selected logbook. Here, lineups or operational scenarios can be generated by selecting either the Lineups or Scenarios buttons in the upper left portion of the page, respectively. Many of the same steps are taken to build/generate scent lineups and detection scenarios, although each are described separately below.

### 2.4.2.1. Generate/Edit Lineups

With the Lineups button selected at the top left of the page, users can generate specific lineups by selecting one of three buttons along the bottom of the page: +Auto-Generate One Lineup, +Auto-Generate Multiple Lineups, or +Add One Lineup.

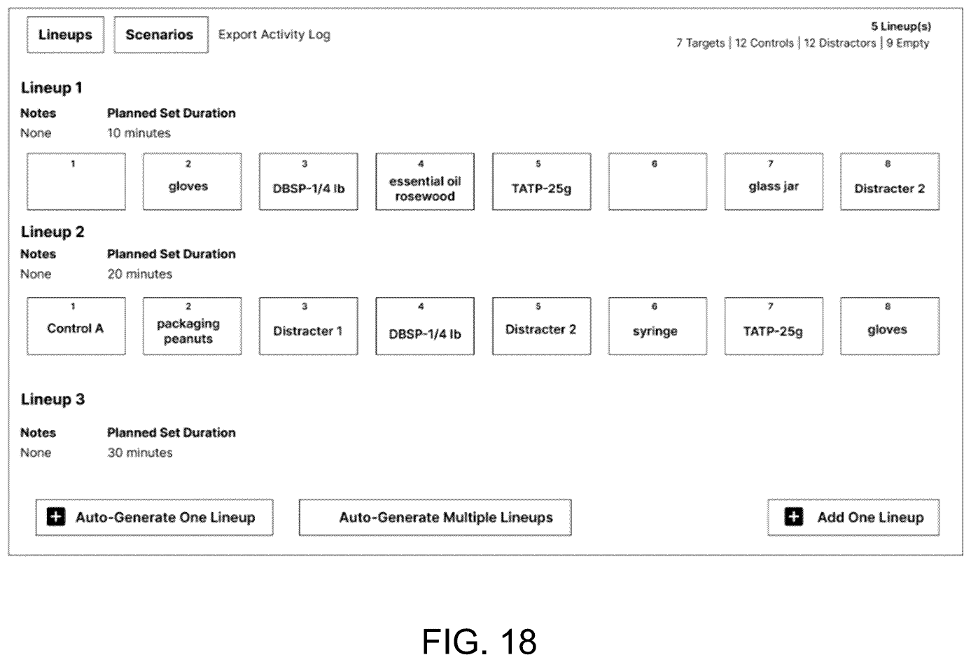

FIG. 18 shows an Example Lineups page according to an embodiment. One may select +Auto-Generate One Lineup to have the evaluation software create a single lineup or select +Auto-Generate Multiple Lineups to have the evaluation software create multiple lineups; a dialog box with a summary of workbench settings will appear for the user to confirm before auto-generating the lineup(s). If all settings are correct, select the Generate button; if, however, any settings need to be modified, select the Go to Workbench button. The evaluation software will jump back to the Workbench/Lineups page (Section 2.4.1.2) where changes can be made. (The user will then have to navigate back to the Build Exercises page manually.) Select +Add One Lineup to add a blank lineup box to the page; items can be added using menu functions within the lineup box described in the sections below. As lineups are created, a running tally of the number of lineups, targets, controls, distracters, and blanks (empty) is provided in the upper right corner of the page, as seen in FIG. 18.

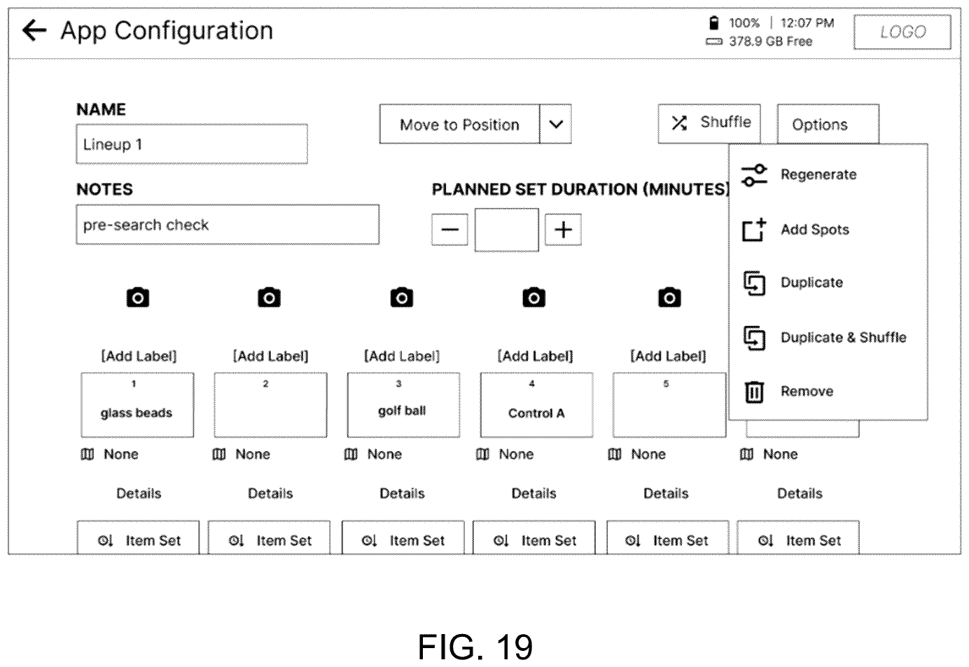

FIG. 19 shows an example of an Edit Lineup Details page. Details within a single lineup can be edited by first tapping the lineup name, or anywhere above the colored tiles, to open the edit page. The functionality of each button and feature are described below.

Name/Notes. This text can be modified by typing directly into the text boxes.

Move to Position. One may select the Move to Position drop-down menu to modify the relative position of this lineup to the other lineups on the Build Exercises/Lineup page. The “current position” of the lineup is indicated in the drop-down menu.

Shuffle. One may select Shuffle to rearrange the items to different spots in the lineup. All information related to each item (photographs, details, set time) is retained.

Planned Set Duration. One may use the + and − buttons or tap on the number directly to modify the planned set duration.

Options. Five functions can be accessed via the Options drop-down menu. (1) Regenerate. One may select Regenerate to remove the items in the current lineup and, using the rules outlined on the Workbench/Lineup page, regenerate a new lineup. There will be no consideration of previously enforced correlations for multi-lineup generation (e.g., using all targets before reuse). (2) Add Spots. When Add Spots is selected, a dialog box will appear. Enter in the number of additional items desired and select Add. The new tile(s) will be placed at the end of the lineup. If a lineup was manually added via the +Add One Lineup button, use the Add Spots function to create spots in that lineup. (3) Duplicate. One may select Duplicate to generate an exact duplicate of the current lineup into a new lineup in the next position beneath the current lineup (all other lineups will be moved down one position.) The name of the new lineup will include the name of the old lineup with a −# added (e.g., Lineup 1-1, Lineup 1-2). (4) Duplicate & Shuffle. This action generates duplicate lineups as outlined above, but randomly shuffles the items in the lineup to a different order. (5) Remove. One may select Remove to delete a lineup. A dialog box will ask the user to confirm that the user wants to Remove or Keep the lineup.

Camera. A picture of the item can be added for visual confirmation by tapping on the camera above the item. A dialog box will appear the first time this option is attempted, and access to the camera will have to be granted to the evaluation software.

[Add Label]. A text entry can be added to further describe the photograph/spot by tapping on [Add Label].

Item Set/Return. These buttons can be tapped to record the time that an item is placed into the lineup (Set) or removed from the lineup (Return). The time is automatically filled from the internal clock on the device. This time can be manually added/changed via the Details button.

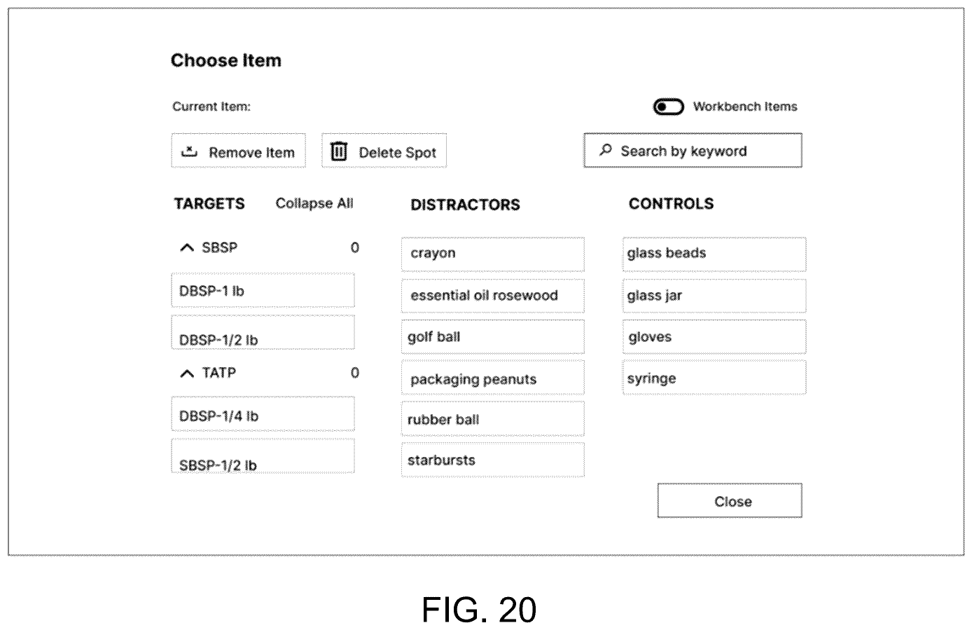

Item Tile. FIG. 20 shows an example of a Choose Item in Lineup page. The item in the box can be changed by tapping on the item tile. This action opens a dialog box of FIG. 20 from which another item can be selected from the list provided. The toggle on the upper right corner changes the items displayed between those included in the Workbench, and all items entered during App Configuration. The search bar can be used to search the item lists by keyword. The item in the box can be removed from the spot by selecting Remove Item; this action leaves the spot empty. Or, if desired, the entire spot can be deleted from the lineup by selecting the Delete Spot button.

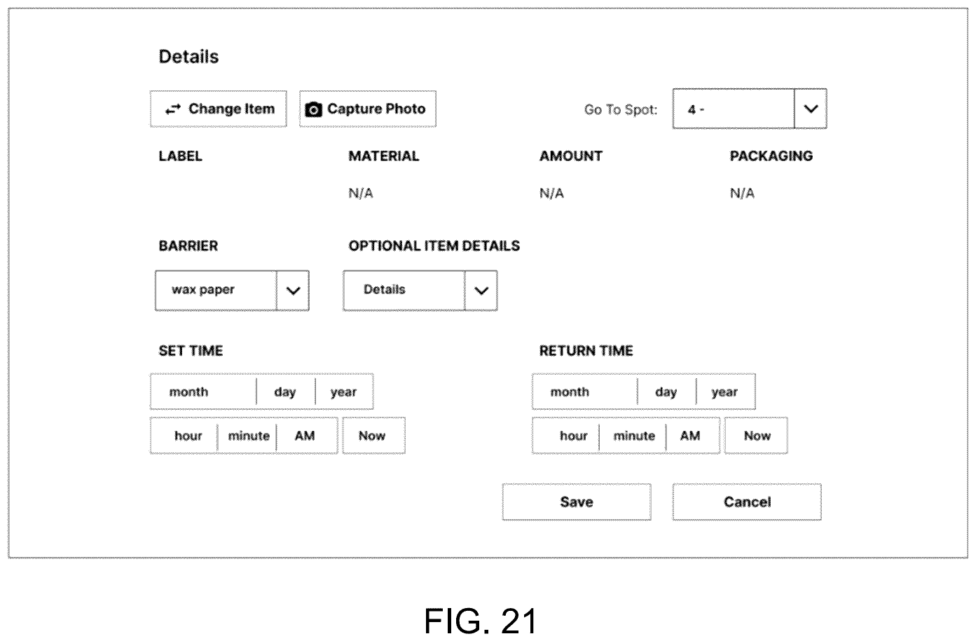

Details. FIG. 21 shows an example of an Item Details (Lineups) page. Selecting the Details button (in FIG. 19) under a specific item opens a dialog box of FIG. 21 that allows the user to enter/modify many item details. Change Item. One may tap Change Item to change the item from the list of those provided (FIG. 20). The Label, Material, Amount, and Packaging are then displayed in the Details dialog box. Capture Photo. One may tap the Capture Photo button to access the camera and record a picture of the item, as described under the Camera section above. Go to Spot. One may select the Go to Spot drop-down menu to change between the details of each spot in the lineup without having to exit the Details dialog box. The spot number and contents are included in the drop-down menu to help navigate. Barrier. One may select the Barrier drop-down menu to specify the barrier used (if any) with this item. The default barrier setting is None. Optional Item Details. One may tap the Optional Item Details drop-down menu to select from the details entered during App Configuration (Section 2.2.2.1). Set Time and Return Time. Values can be entered automatically by selecting the Now button; the date and time from the device are entered into these fields. The Reset button removes these values from the dialog box. Date and time can be entered manually by selecting the month/day/year or hour/minute/AM/PM box and advancing the arrows to the correct date and time. One may press the check mark to save or the X to cancel. Notes. Additional notes may be entered into a Notes field (not shown).

### 2.4.2.2. Generate/Edit Scenarios

With the Scenarios button selected at the top left of the Build Exercises page, users can generate specific operational scenarios by selecting one of three buttons: +Auto-Generate One Scenario, +Auto-Generate Multiple Scenarios, or +Add One Scenario.

One may select +Auto-Generate One Scenario to have the evaluation software create a single scenario or select +Auto-Generate Multiple Scenarios to create multiple detection scenarios; a dialog box with a summary of Workbench settings will appear for the user to confirm before generating the scenario(s). If all settings are correct, one may select the Generate button. If any settings need to be modified, one may select the Go to Workbench button. The evaluation software will jump back to the Workbench/Scenarios page (discussed in Section 2.4.1.3) where changes can be made. (The user will then have to manually navigate back to the Build Exercises page.) One may select +Add One Scenario to add a blank scenario to the page; items can be added via the Options menu described below.

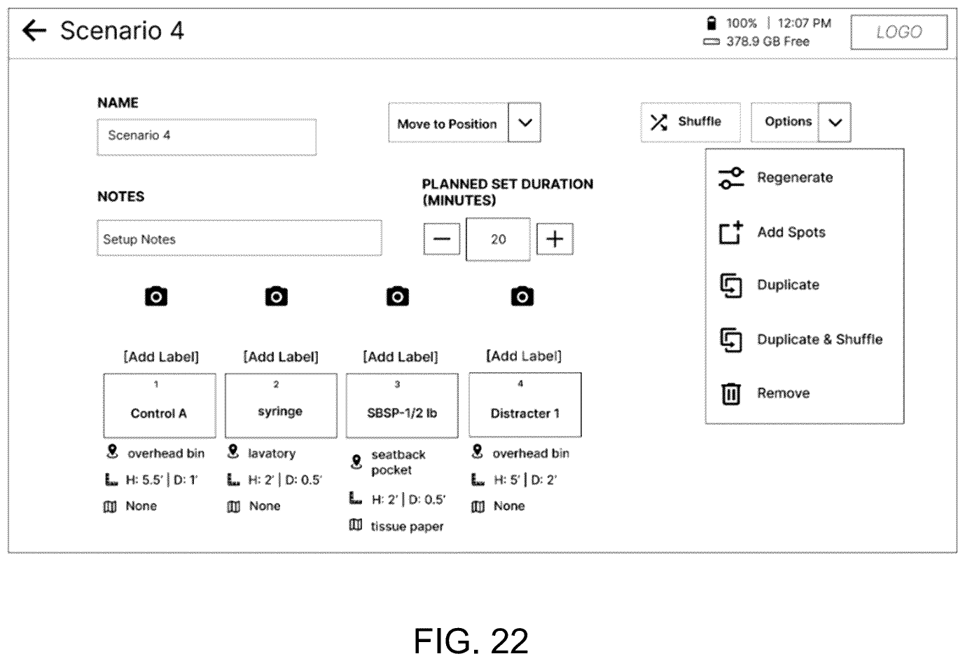

FIG. 22 shows an example of an Edit Scenario Details page. Scenario details can be edited by first tapping on the scenario name, or anywhere above the colored tiles, to open the edit page. The functionality of each button and feature are described below.

Name/Notes. This text can be modified by typing directly into the text boxes.

Move to Position. One may select the Move to Position drop-down menu to modify the relative position of this scenario to the other scenarios on the Build Exercises/Scenarios page. The “current position” of the scenario is indicated in the drop-down menu.

Shuffle. One may select Shuffle to rearrange the items to different spots relative to each other within the scenario. All information related to each item (e.g., photographs, details, set time) is retained.

Planned Set Duration. One may use the + and − buttons or tap on the number directly to modify the planned set duration.

Search Area. The type of search area can be selected from the Search Area drop-down menu.

Options. Five functions can be accessed via the Options drop-down menu. (1) Regenerate. One may select Regenerate to remove the items in the current scenario and, using the rules outlined on the Workbench/Scenario page, regenerate with new items. There will be no consideration of previously enforced correlations for multi-scenario generation (e.g., using all hide locations before reuse). (2) Add Items. When Add Items is selected, a dialog box will appear. One may enter the number of additional items desired and select Add. If a scenario was manually added via the +Add One Scenario button, one may use the Add Items function to create items in that scenario. (3) Duplicate. One may select Duplicate to generate an exact duplicate of the current scenario into a new scenario in the next position beneath the current scenario (all other scenarios will be moved down one position.) The name of the new scenario will include the name of the original scenario with a −#added (e.g., Scenario 1-1, Scenario 1-2). (4) Duplicate & Shuffle. This action generates duplicate scenarios as outlined above, but randomly shuffles the items within the scenario to a different order. (5) Remove. One may select Remove to delete a scenario. A dialog box will ask the user to confirm that the user wants to Remove or Keep the scenario.

Camera. A picture of the item can be added for visual confirmation by tapping on the camera above the item. A dialog box will appear the first time this action is attempted, and access to the camera will have to be granted to the evaluation software.

[Add Label]. A text entry can be added to further describe the photograph/spot by tapping on [Add Label].

Item Set/Return. These buttons can be tapped to record the time that an item is placed into the scenario (Set) or removed from the scenario (Return). The time is automatically filled from the internal clock on the device. This time can be manually added/changed via the Details button.

Item Tile. The item in the box can be changed by tapping on the item tile. This action opens a dialog box (similar to FIG. 20) from which another item can be selected from the list provided. The toggle on the upper right corner changes the items displayed between those included in the Workbench, and all items entered during App Configuration. The search bar can be used to search the item lists by keyword. The item can be deleted from the scenario by selecting the Delete Spot button.

Details. Selecting the Details button (in FIG. 22) under a specific item opens a dialog box (similar to FIG. 21) that allows the user to enter/modify many item details. Change Item. One may tap Change Item to change the item from the list of those provided (FIG. 20). The Label, Material, Amount, and Packaging are then displayed in the Details dialog box. Capture Photo. One may tap Capture Photo to access the camera and record a picture of the item, as described under the Camera section above. Go to Spot. One may select the Go to Spot drop-down menu to change between the details of each item in the scenario without having to exit the Details dialog box. The item number and contents are included in the menu to help navigate. Barrier. One may select the Barrier drop-down menu to specify the barrier used (if any) with this item. The default barrier setting is None. Optional Item Details. One may tap the Optional Item Details drop-down menu to select from the details entered during App Configuration (Section 2.2.1). Hide Location. The hide location can be changed by tapping the Hide Location drop-down menu and selecting the new hide location from the list of those available. Hide Height/Hide Depth. If not auto-generated by the evaluation software (see settings in Section 2.2.2) the height and depth of the hide can be recorded here by selecting the box and entering the numerical values in feet (ft). Optional Hide Details. One may tap the Optional Hide Details drop-down menu to select from the details entered during App Configuration (Section 2.2.2). Set Time and Return Time. Values can be entered automatically by selecting the Now button; the date and time from the device are entered into these fields. The Reset button removes these values from the dialog box. Date and time can be entered manually by selecting the month/day/year or hour/minute/AM/PM box and advancing the arrows to the correct date and time. One may press the check mark to save or the X to cancel. Notes. Additional notes may be entered into the Notes field.

### 2.4.3. Export Activity Log

An Export Activity Log button is available under both the Lineups and Scenarios build pages. This function allows the user to export all of the steps taken to create the exercises for that logbook build into a Microsoft Excel spreadsheet. Once the Export Activity Log button is selected, a save dialog appears with the Logbook Title as the Excel file name. The file is set to save to the Desktop, or another directory folder can be selected. One may press Save to complete the export.

### 2.4.4. Record Results

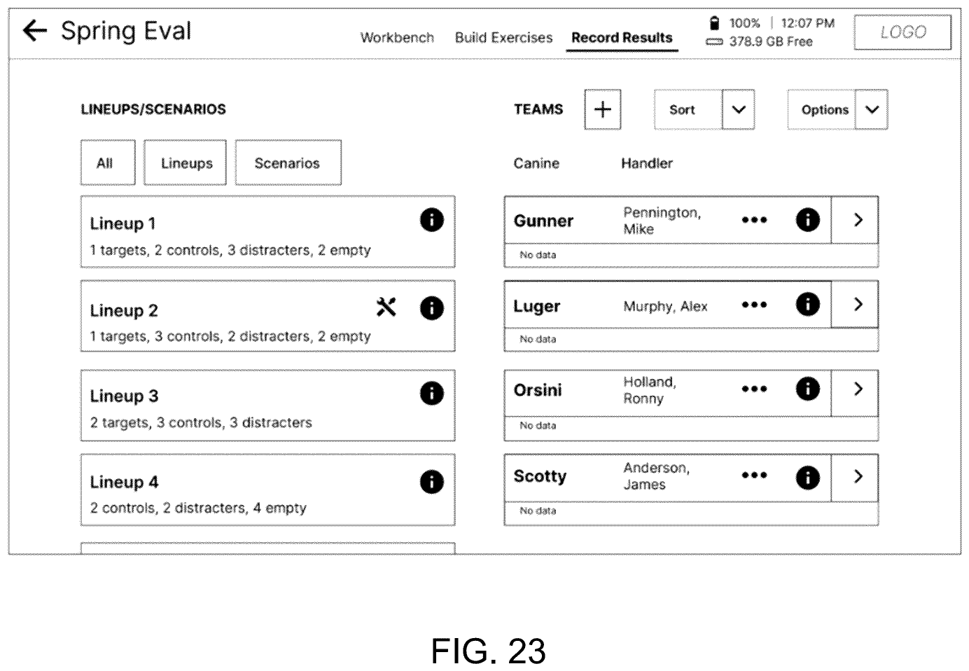

FIG. 23 shows an example of a Record Results page. The Record Results page will list all exercises built and all teams added to the logbook. FIG. 23 displays the launch page to begin capturing outcomes for a select lineup/scenario and team (detailed in Section 2.4.4.4). Several additional options are available from this page and are detailed in the subsections below.

### 2.4.4.1. Create Teams

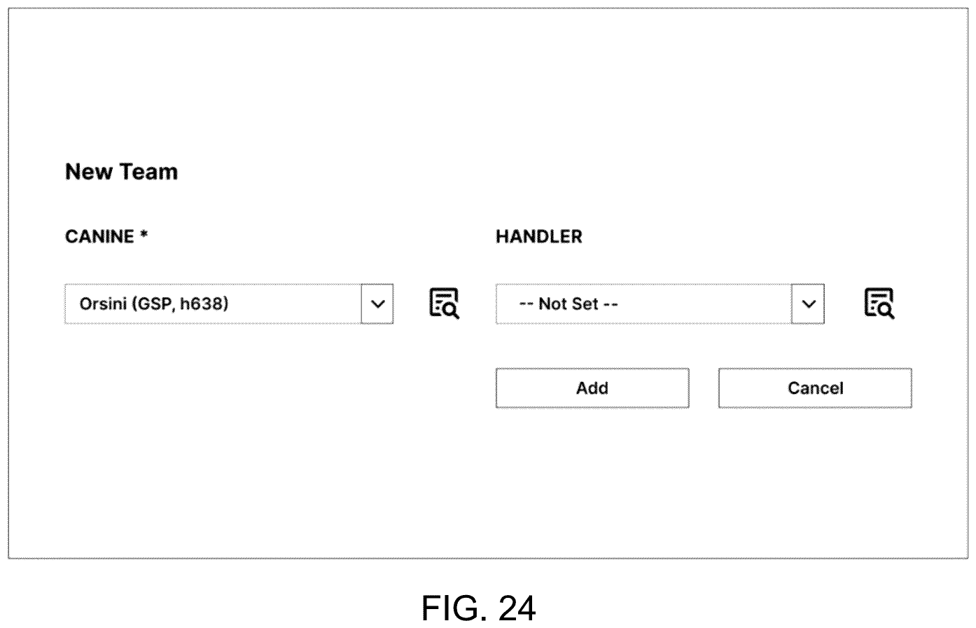

FIG. 24 shows an example of an Add New Teams page. In the section of the page labeled Teams, one may select the Plus icon to open the New Team dialog box. (If no canines or handers have been entered, the evaluation software will notify the user and send them to the Canines & Handlers page (Section 2.3)). A new team can be created by tapping the Canine box and selecting the name from the drop-down menu, and then tapping the Handler box and selecting the handler's name from the drop-down menu. One may press Add to save the entries as a team. The handler may be left as Not Set if it is not known at that time who will be handling the dog during data collection. That information can be entered later under the Edit Team function accessed by selecting the “ . . . ” ellipsis next to the team name and then Edit Team. The team can also be deleted by selecting the “ . . . ” ellipsis next to the team name and then Remove. A dialog box will ask the user to confirm the action prior to deleting the team. (Additional functionality in the “ . . . ” ellipsis menu is described in Section 2.4.4.4.)

Once several teams have been created, the order of the list of teams can be sorted alphabetically by handler last name, canine name, or run order by tapping the Sort Teams button and then the desired sort function from the drop-down menu.

### 2.4.4.2. Generate Run Order

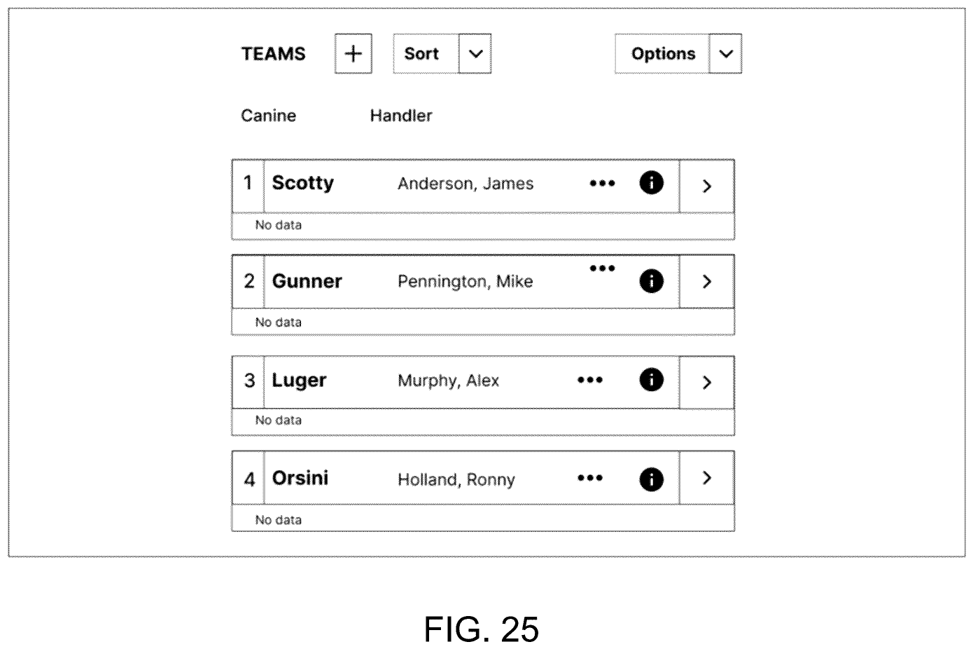

FIG. 25 shows an example of a Generate Run Order page with number added to team tile. A run order (the order in which teams perform each lineup/scenario) can be randomly generated by the evaluation software by first selecting the specific lineup/scenario to be run, then tapping the Options button and tapping on Generate Run Order. This action will randomly order the teams and incorporate that run order number into the team tile, as seen in FIG. 25. One may repeat these steps to generate a new run order for each individual lineup or scenario.

### 2.4.4.3. Create Score Sheets

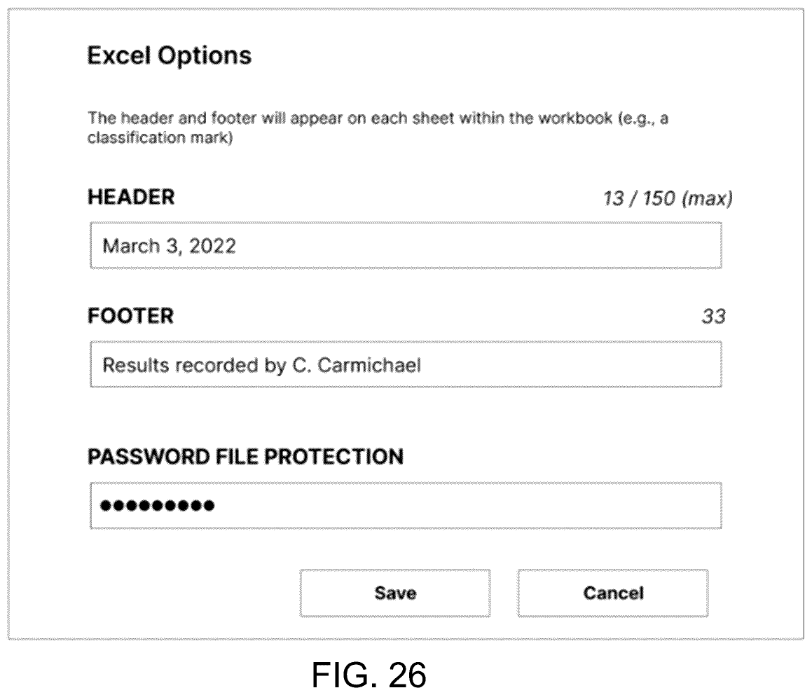

FIG. 26 shows an example of an Export Microsoft Excel Data Sheets page. If the user prefers to manually record performance results onto a score sheet or hand an observer a hardcopy of the day's trials, the evaluation software can generate paper versions of the created exercises. One may select the Options button and tap on Create Score Sheets. One may select the specific lineups/scenarios from the list or select all of them by pressing the Select All button, and then press Export. This action will open a dialog box of FIG. 26 into which specific headers and footers can be applied to the exported records sheets, if desired. A password can also be applied to the exported file by entering it into the dialog box before tapping Continue. A save dialog appears for the user to specify a file name and location before tapping Export to finish the process. The evaluation software will confirm the export and provide another dialog box to allow the user to open the file at that time (Open File) or close the dialog box (Close) and return to the Export page. One may tap on the Cancel button to return to the Record Results page.

### 2.4.4.4. Results Entry

On the Record Results page, all lineups/scenarios built within that logbook are listed. To start recording results, the user selects a single lineup or scenario to be run and then the team to be scored by tapping the Caret icon on the team tile. This action opens the Results Entry page.

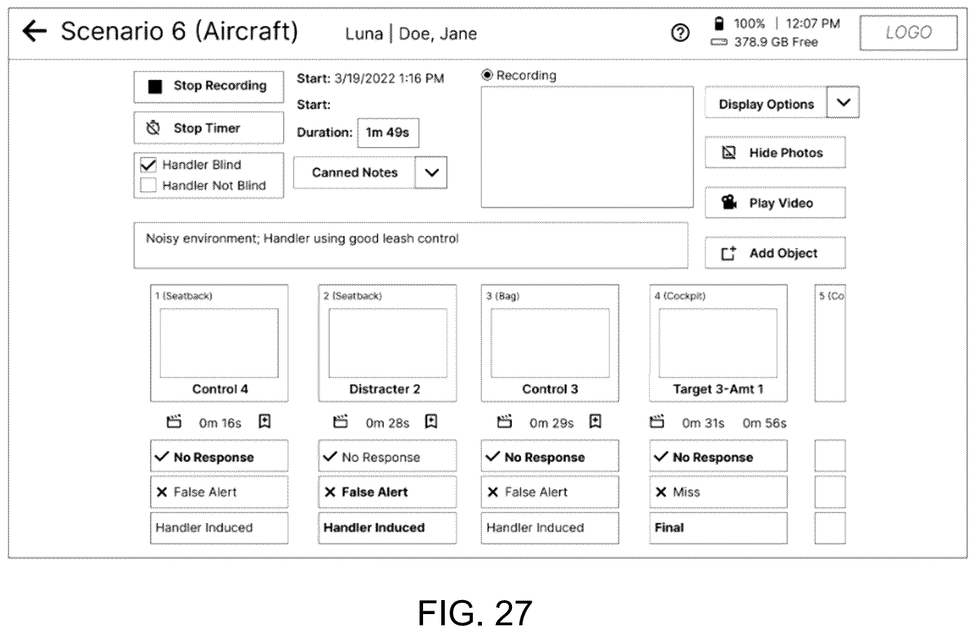

FIG. 27 shows an example of a Results Entry page. Among other buttons and information on the Results Entry page, that particular lineup/scenario is displayed as a row of tiles, with each tile representing an item (target or otherwise) in that exercise. If images of the items/hides were captured back on the Build Exercises page, the user can opt to display them within the corresponding tiles on this page. The functionality of the buttons, menus, and tiles on this page are described below.

Start/Stop Recording. One may tap Start/Stop Recording to begin recording video. When recording starts, the stopwatch will start as well. Video will display to the right of the button. One may tap again to stop recording (the stopwatch will continue). If the button is tapped again to resume video recording, it will save into a new video file.

Start/Stop/Resume Timer. One may tap Start/Stop/Resume Timer to start the stopwatch for the search. Tapping the button again will stop the timer. Tapping the button a third time will resume the stopwatch from where it previously left off.

Handler Blind/Not Blind. One may check the appropriate Handler Blind/Not Blind box to record whether the search was performed blind/not blind (i.e., handler knows/does not know the location of the target). The evaluation software will prompt the user to record this information before exiting the page.

Observations. Notes can be typed into the Notes and comments text box or selected from the Canned Notes drop-down menu. Multiple canned notes can be added. The canned notes available in this menu can be modified via the App Configuration page as outlined in Section 2.2.3.

Display Options. This menu allows the user to select Multi-Exposure Controls or Clock Time Format. Multi-Exposure Controls. This option adds pass counters to each item in the exercise so that multiple responses to an item can be tracked. One may use the + and − buttons to add additional column(s) of response options so that responses to each “exposure” can be recorded. Clock Time Format. When a performance result is recorded, the time at which that action occurred is displayed (i.e., the number of minutes/seconds since the search began). One may use the Clock Time Format to display these time logs in a clock format instead of the default Search Time counter.

Show Photos/Hide Photos. One may toggle Show Photos/Hide Photos to display/hide the photographs associated with the items in the search.

Play Video. One may tap Play Video to launch the video player and watch videos associated with this search. Video clips can also be exported as stand-alone files by tapping Export Clip, which will give users the option to export the whole video, or ±15 seconds, 30 seconds, or 1 minute from the current position in the video. Users will be prompted to select a file location to export the video.

Add Object. One may tap Add Object to add another object to a lineup or scenario. Once placed, a picture can be added by tapping the Camera icon, notes can be added by tapping the Page icon, or the spot/item can be deleted by tapping on the Trash Can icon. The recorded response to this item automatically defaults to False Positive, as the most common use of this button is to record a response to an item not originally included/established in the search area.

The remainder of the Results Entry page displays the item tiles and Primary and Secondary scoring options. (Scoring details are defined in Section 2.2.3.) The user selects one of the Primary score options for each item in the exercise, otherwise that item will not be counted in the results. Secondary score options (listed below the faint horizontal line) are optional, multi-select in nature, and created by the user (within App Configuration) to quickly capture other fine/important details or observations. To begin entering results, start the video (if desired), start the stopwatch, or just start recording results (e.g., tap on the score options under the item tiles). The stopwatch will automatically begin tracking time once any data collection starts. As the team moves through the exercise, the user simply taps the correct outcome/details to log them for each item.

When an outcome is recorded, the time at which that action occurred is displayed (i.e., the number of minutes/seconds since the search began). The user can also tap the Bookmark icon next to the time stamp to indicate when something noteworthy occurs with that item (e.g., a dog shows aggressive behavior). Tapping this Bookmark icon a second time will allow the user to update the bookmark to 1) the current time, by tapping Update to [Xm Xs] or 2) reset the bookmark by tapping Reset. Bookmark stamps are helpful tools to jump directly to an incident when reviewing video.

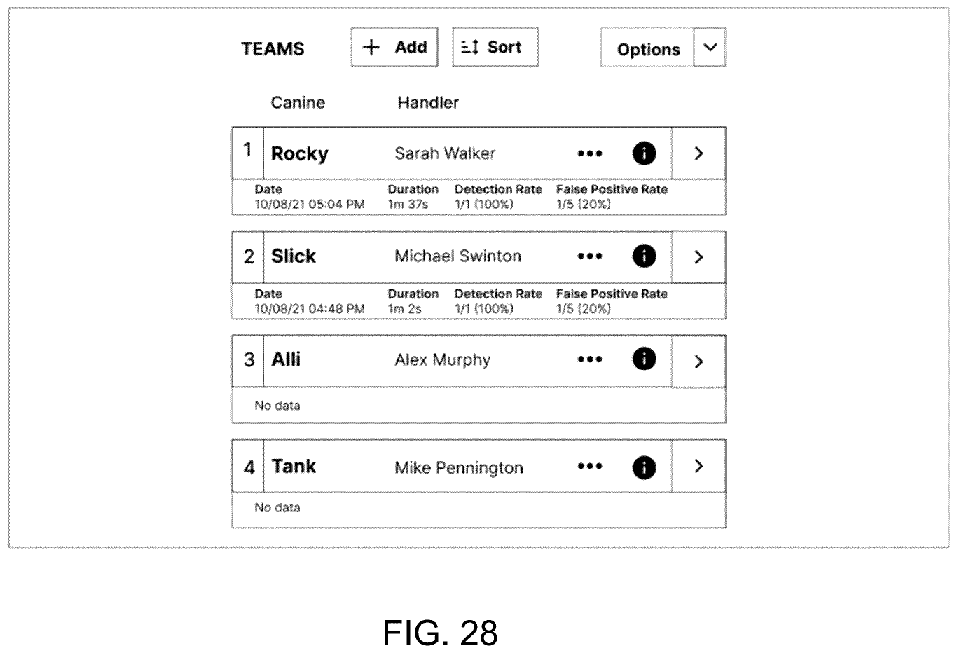

FIG. 28 shows an example of a Summary of Results Under Team Name page. When the search is complete, tap on Stop Timer (this stops the timer and any video recording). To return to the Record Results page to run the next dog, tap on the arrow in the top left corner next to the lineup/scenario name. (Leaving the page will also stop the stopwatch.) A summary of results will appear beneath the team name on the Record Results page, as shown in FIG. 28.

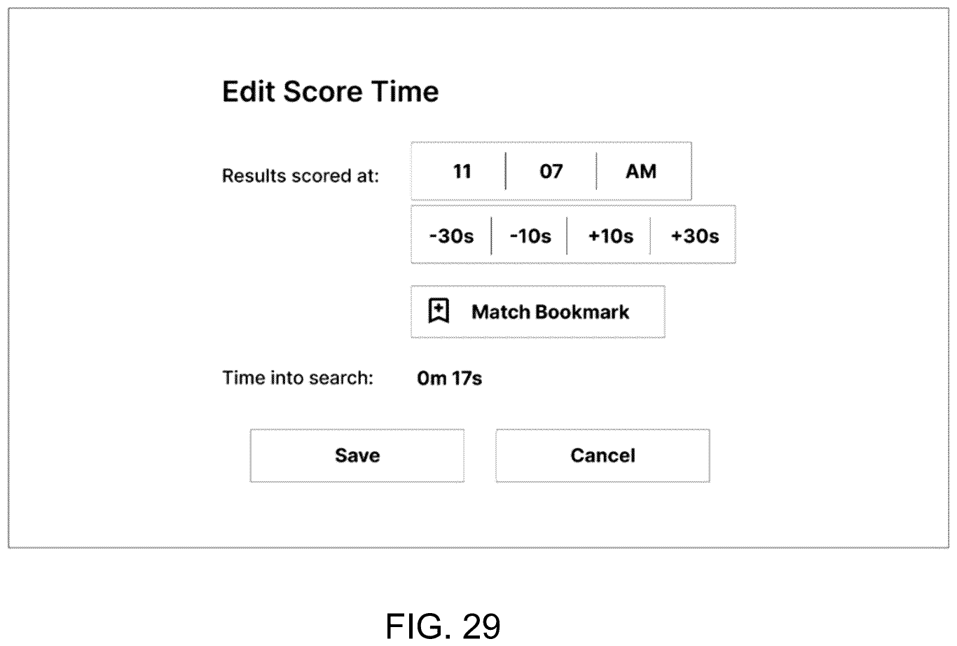

FIG. 29 shows an example of an Edit Score Time page. If the user returns to a Results Entry page after results have already been recorded, the page will indicate that “previously collected results are locked,” but provides the option to “unlock” the results if changes need to be made. For example, to edit the time at which an interaction was scored, tap the time stamp under the item tile to launch a dialog box of FIG. 29. Here, the user can adjust the time by tapping the time and scrolling or by jumping forward/back by 10 or 30 seconds. The user may also adjust the score time to match the bookmark (if one has been recorded) by tapping Match Bookmark. To save these adjustments, the user taps Save, or to leave the time as originally recorded, taps Cancel. Users can also review the video to check data entry and then modify the time stamp or any other information under the item tiles. One may tap the Clapperboard icon next to the time stamp to launch the video player to the moment the interaction was recorded or tap Play Video to watch from the beginning.

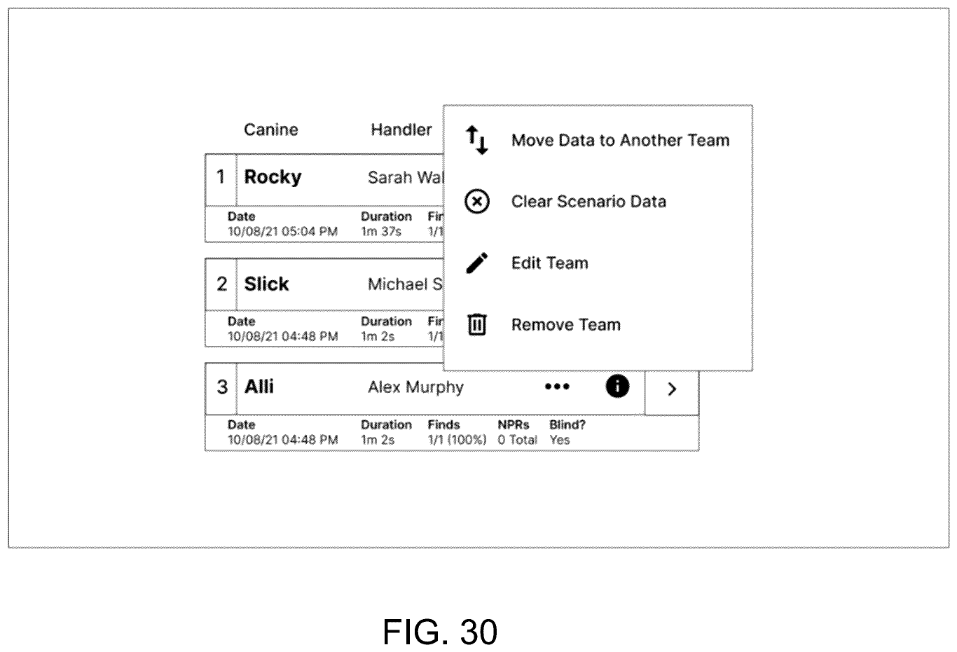

FIG. 30 shows an Example of a Menu Under Team Name page. Once the user returns to the Record Results page, additional menu options are available under the “ . . . ” ellipsis menu on each team tile.

Move Data to Another Team. If results were recorded under the wrong team name, the results can be transferred by tapping the “ . . . ” ellipsis on the team with the collected results, selecting Move Data to Another Team, and then selecting the team to which the data should be transferred from the drop-down menu. Data can only be transferred to a team that has not yet been scored. If two teams (A and B) need to swap data, the user will need to create a third team (C) so that results from A are transferred to C, results from B are transferred to A, and then results from C are transferred to B. The third, fake team is then deleted.

Clear Scenario Data. Recorded results can be erased by selecting the “ . . . ” ellipsis on the team name, then selecting Clear Scenario Data. A dialog box will ask the user to confirm the action before the data are deleted.

### 2.4.4.5. Create Results Summary Report

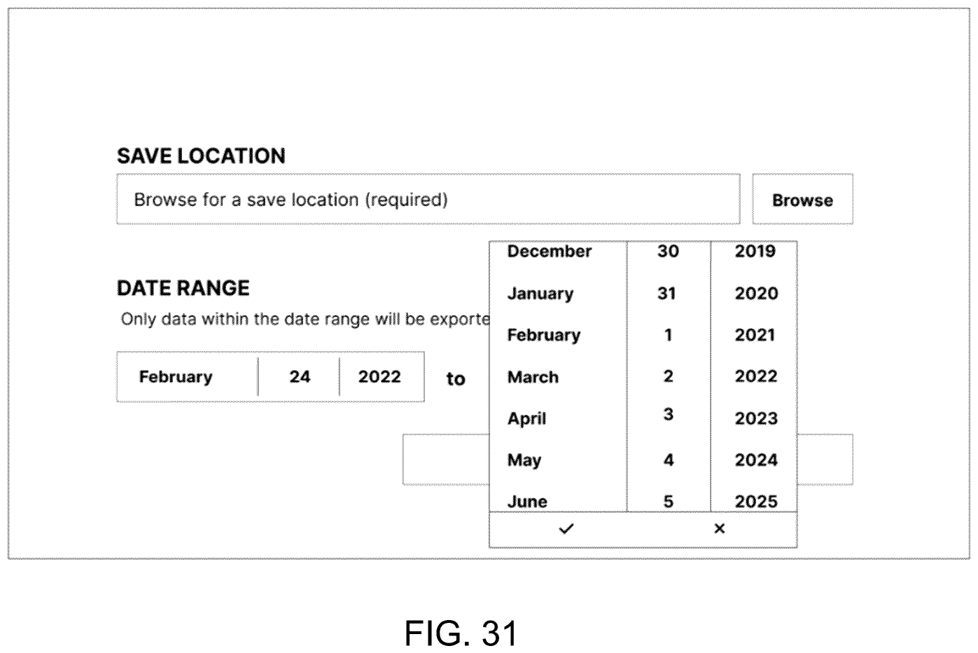

FIG. 31 shows an example of a Create Results Summary Report page. A summary of results collected under a single logbook can be generated and exported to an Excel spreadsheet. The results are summarized in aggregate across all teams and then individually by team in separate tabs of the exported spreadsheet. From the Record Results page (FIG. 23), select the Options drop-down menu and then Create Results Summary Report. This action will open a dialog box of FIG. 31 into which the save location can be typed directly or browsed (Browse button). The date range for the report can also be specified by tapping on the date boxes and advancing the arrows to the correct month, day, and year. One may press ✓ to save or X to close. Once a save location and date range are selected, one may press Export to continue. This action will open a dialog box (similar to FIG. 26) into which specific headers and footers can be applied to the exported summary report, if desired. A password can also be applied to the exported file by entering it into the dialog box before tapping Continue. A save dialog appears for the user to specify a file name and location before tapping Export to finish the process. The evaluation software will confirm the export and provide another dialog box to allow the user to open the file at that time (Open File) or close the dialog box (Close) and return to the Record Results page.

### 2.4.4.6. Data Export From Record Results Page

On the Record Results page, an Options drop-down exists and leads to the ability to Export Logbook Data; this option yields a Microsoft Excel file that contains two tabs, one containing all the data from the lineups in that given logbook and one containing all the data from the scenarios in that same logbook. Specifically, in this Excel file, every exposure to every item in that one logbook will exist as one row, and the columns of that row will specify the involved canine, responsible handler, placement details and times, outcome/scores, notes, and more. With this ability, users can plot, filter, and analyze the data outside of the evaluation software should they wish to do so.

### 2.4.4.7. Printable Outputs From Record Results Page

While intended, and capable of being, an entirely digital solution, the evaluation software can create select files for printing and use in hardcopy form in the event that need arises for the user. From the Record Results page, the Options drop-down presents the ability to Create Score Sheets; this option yields a Microsoft Excel file that contains a printable page for each selected lineup/scenario, allowing the user to record results for that exercise on paper. Under this same Options button, the Create Results Summary Report generates an aggregate and per team data summary report (in Excel) that is formatted for printing and sharing via hard copy.

### 2.5. Analytics

Accessible from the Home page or the Main Menu, the Analytics page allows users to aggregate, view, and analyze the results from one or more logbooks. If desired, the selected logbooks' results that are tallied/displayed on the screen can be focused to be within a given date range. The displayed results can also be focused on one or more parameters of interest (e.g., a specific canine, a specific target material) using built-in filters. Finally, the data can also be grouped in various ways. As such, the user can use the Analytics page to monitor progress, look for problematic trends, and make comparisons to better understand and guide their efforts and program in general.

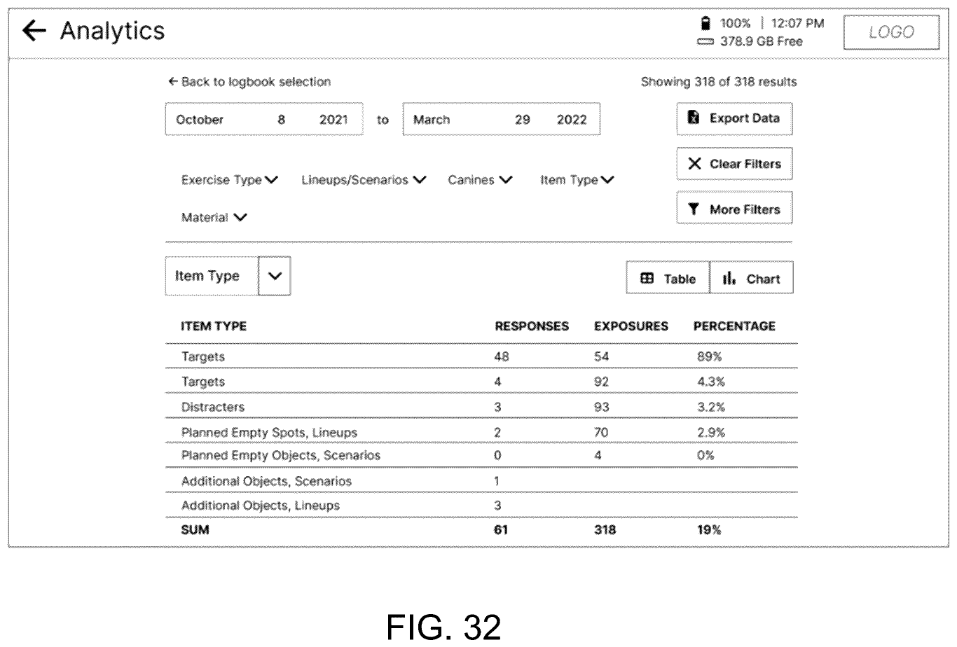

FIG. 32 shows an example of an Analytics page for item type and table. The Analytics page allows users to aggregate, view, and analyze the results from one or more logbooks. This page can be accessed by tapping the Main Menu icon and selecting Analytics or by selecting the Analytics tile from the Home page. The user is first prompted to select the logbooks to be included. One may tap on an individual logbook, multiple logbooks, or even Select All, depending on the need. One may select the Continue to Analytics button to proceed. The tallied results, summing across all selected logbooks, are then displayed as seen in FIG. 32. The functionality of the buttons and menus on this page are described below.

Back to Logbook Selection. One may tap Back to Logbook Selection to return to the page where logbooks are included/excluded from the analysis.

Date Range. If desired, the selected logbook results that are tallied/displayed on the screen can be focused to be within a given date range. One may specify the date range of interest by tapping on the date boxes at the top of the page and adjust the month, day, and year spinners accordingly. One may press ✓ to save the selected date or X to cancel. The results will update automatically to conform to this date range.

Filters. The tallied/displayed results can also be focused on one or more parameters of interest (e.g., a specific canine, a specific target material) using the drop-down filters near the top of the page. To access any of these filters, one may tap on the filter name (e.g., Canines). A drop-down list will show all underlying options; select one or more options to include/exclude, and then tap Apply. The results will update automatically. In addition, the filter will display in bold type and have a rectangle around it when it is restricting that which is being tallied. Within a drop-down list, options will be hidden if the state of another filter precludes them from being selected (e.g., if only Targets are selected under Item Type, all non-targets will be hidden in the Material list). All filters can be reset (removed) by tapping the Clear Filters button. One may select More Filters to gain access to additional filtering options.

Group By. With the selected date and parameter filters still intact, it is also possible to group the results several different ways. These options are accessible via the white and light blue drop-down that defaults to Item Type.

Table/Chart. The results can be displayed in table or chart format by selecting either the Table or Chart button.

Export Data. To export the data currently displayed on the Analytics page (i.e., with any filters in place) as a Microsoft Excel file, one may select the Export Data button. This action will open a save dialog for the user to specify a file name and location before tapping Export to finish the process.

### 2.5.1. Data Export From Analytics Page

Similar to the export to Excel introduced in Section 2.4.3, the Export Data button on the Analytics page allows the user to quickly transfer data sets to Excel format. However, when generated here, the resulting Excel file will obey the selections and filters, meaning that the resulting file could span multiple logbooks and will omit any data precluded by the filters.

### 2.6. Data Management

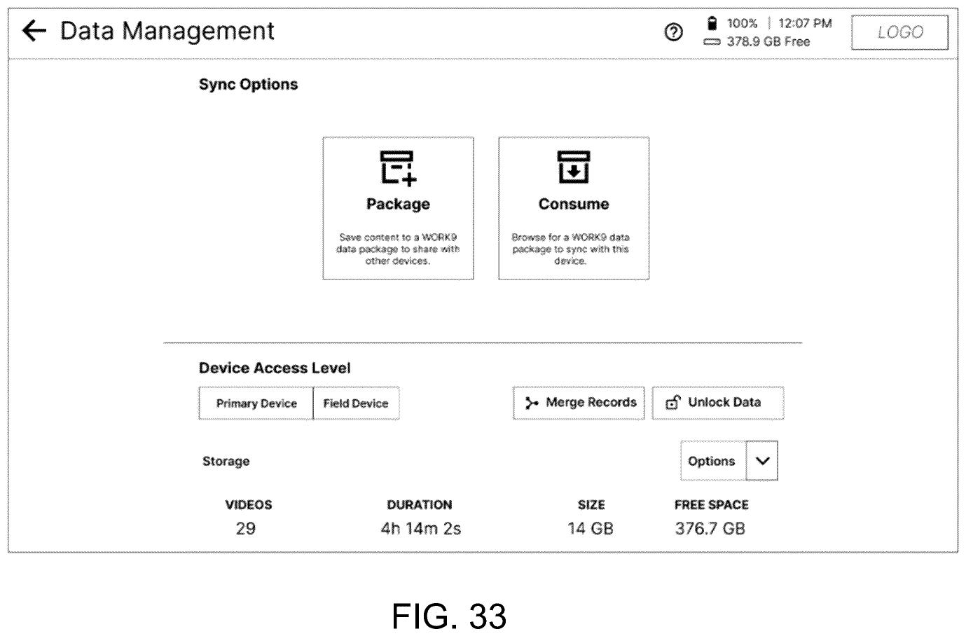

FIG. 33 shows an example of a Data Management page. The Data Management page is accessible from the Main Menu and provides functions/controls needed to perform key administrative actions, including archiving the files on that device and/or reading in files from a different device. The Data Management page provides functions/controls needed to perform key administrative actions, including archiving the files on that device and/or reading in files from a different device. This page is accessed by tapping the Main Menu icon, then Data Management. Once here, the user can employ Sync Options, set the Device Access Level, and view/set Storge parameters.

### 2.6.1. Primary Device/Field Device

Devices are designated as Primary or Field to set the level of access to the evaluation software database. It is recommended that only one device within an organization be set as the Primary device, while the remaining devices are deployed with Field level access. Field devices provide access to all features needed to build exercises, capture results and video, analyze data, and generate reports. However, they are meant for temporary storage and should be regularly divested of logbooks to the Primary device/computer, which functions as the comprehensive archive. Primary devices are also able to unlock data and merge records to aid in the management of the database.

### 2.6.2. Database Packaging/Consumption

The core purpose of Data Management is to facilitate synchronization among devices. This functionality is intended to be used regularly to archive logbooks from Field devices into the Primary repository. It will also be instrumental in the initial rollout of, and periodic updates to, App Configuration settings to Field devices.

Synchronization is a two-step process. First, information is “packaged” on one device and, second, the packaged information is uploaded, or “consumed” by a different device. The data packaging process is identical for Primary and Field devices, but the generated file is marked with this designation and impacts the options available when later consuming the data.

If a Field device consumes a data package designated “Primary,” the user will have the option to:

Clear & Reload, where all records on the device will be deleted and content from the incoming package will be loaded onto the device.

Add New & Update Existing, where new content will be added and existing records on the device will be updated to match the incoming package (e.g., a handler name correction.)

If a Primary device consumes a data package designated “Primary”, the user will only be able to select Clear & Reload; this option is recommended to reassign a new device as Primary (e.g., when aging hardware is retired). Finally, if a Primary or Field device consumes a data package designated as “Field,” the user will only be able to Add New Only, where new content will be added, but existing records on the device will be unaffected.

### 2.6.3. Database Export

On the Data Management page, an Options drop-down leads to an Export Raw Database option. Through this function, the complete database can be exported as an SQLite file (*.db) to be used independently of the evaluation software. This option allows for organizations to access the software records for use in other compatible platforms, if desired.

### 2.6.4. Storage

The number, total duration, and file size of captured videos, along with the free space on the evaluation software installation drive, are displayed at the bottom of the page to allow users to monitor progress and remaining capacity. Also in this area, the user can access the Options menu to:

Delete Videos by Logbook. One may select this menu item to delete videos by logbook without deleting any other records/data. Such actions may be desired when attempting to free up space on the software evaluation installation drive, or simply when select logbook videos are no longer needed. One may select the logbooks whose videos should be deleted, then tap Delete Videos.

Export Raw Database. One may select this menu item to export the complete database as an SQLite file (*.db) to be used independently of the evaluation software. This option allows for organizations to access the evaluation software records for use in other compatible platforms, if desired.

### 2.6.5. Device Access Level

Devices are designated as Primary or Field to set the level of access to the evaluation software database. It is recommended that only one device within an organization be set as the Primary device, while the remaining devices are deployed with Field level access. Field devices provide access to all features needed to build exercises, capture results and video, analyze data, and generate reports; however, they are meant for temporary storage and should be regularly divested of logbooks to the Primary device/computer, which functions as the comprehensive archive. A Primary device has two additional options on the Data Management page:

Unlock Data. One may tap Unlock Data to unlock all device content. In an unlocked state, the user may change previously scored results, edit canine and handler information, revise logbooks, or adjust App Configuration settings. It is recommended that this option not be used to edit lineups and scenarios that are currently in-use by Field devices; this action can cause synchronization conflicts or inaccuracies. After an unlock event, the device will automatically return to a locked state upon a restart of the evaluation software (Note: records that were created on the Primary device, but have not yet been packaged, will remain unlocked after a restart).

Merge Records. One may tap Merge Records to open the Merge Records page. Here, the user can combine logbooks, canines, handlers, search areas, secondary scoring, or base materials to improve organization or standardize naming conventions. One may tap Commit Merge to finalize the action.

### 2.6.6. Device Access Level

The core purpose of Data Management is to facilitate synchronization among devices. This functionality is intended to be used regularly to archive logbooks from Field devices into the Primary repository. It will also be instrumental in the initial rollout of, and periodic updates to, App Configuration settings to Field devices.

Synchronization is a two-step process—first, information is “packaged” on one device (Section 2.6.6.1) and second, the packaged information is uploaded, or “consumed” by a different device (Section 2.6.6.2).

### 2.6.6.1. Package Data

To export the evaluation software content in a format ready to upload to other devices, select Package on the Data Management page. A notification will appear on the page to remind the user that the data packaging process will lock the packaged logbooks, canines, handlers, and App Configuration settings. Locking these records provides necessary version control, as it is assumed they will then be shared with other devices. If new information is added to locked content (e.g., additional lineups/scenarios, new teams and/or performance results), that new portion will remain unlocked until it is packaged.

The data packaging process is identical for Primary and Field devices, but the generated file is marked with this designation and impacts the options available when consuming the data (see Section 2.6.6.2).

To package all logbooks, the complete canine and handler lists, and the App Configuration settings, tap Package All Content. It is predicted that this action will be the typical packaging option/approach for most Field device users, even Field devices that merely need to archive new logbooks or logbook entries to the Primary device. Even under this “all content” option, the action to include recorded video in the package will be selected by the user by tapping Include Videos. One may tap Create Package to continue. In the resulting popup window, confirm or edit the name of the data package and save location, and then click Create Package. Note that a drive other than the resident hard drive (e.g., a micro-SD card or a USB memory stick) may be selected as the package save location. A new popup will confirm whether the packaging was a success and provide the user the option to Restart (an application restart is required to reflect the new locked status of the logbooks/information), Open File Location, or Close the popup window.

Alternatively, a subset of the files/data can be packaged by tapping Select Content to Package, highlighting the specific logbook(s), App Configuration, or Canine and Handler list, and then Create Package. Again, recorded video will be selected separately, if desired; if a subset of logbooks are selected, the Include Videos button will only include those videos tied to the selected subset.

### 2.6.6.2. Consume Data

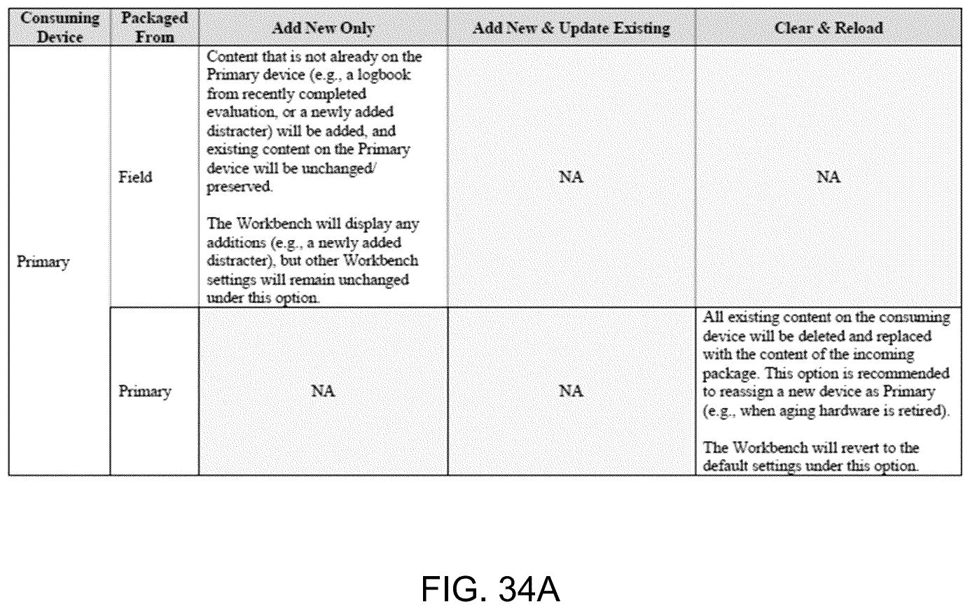

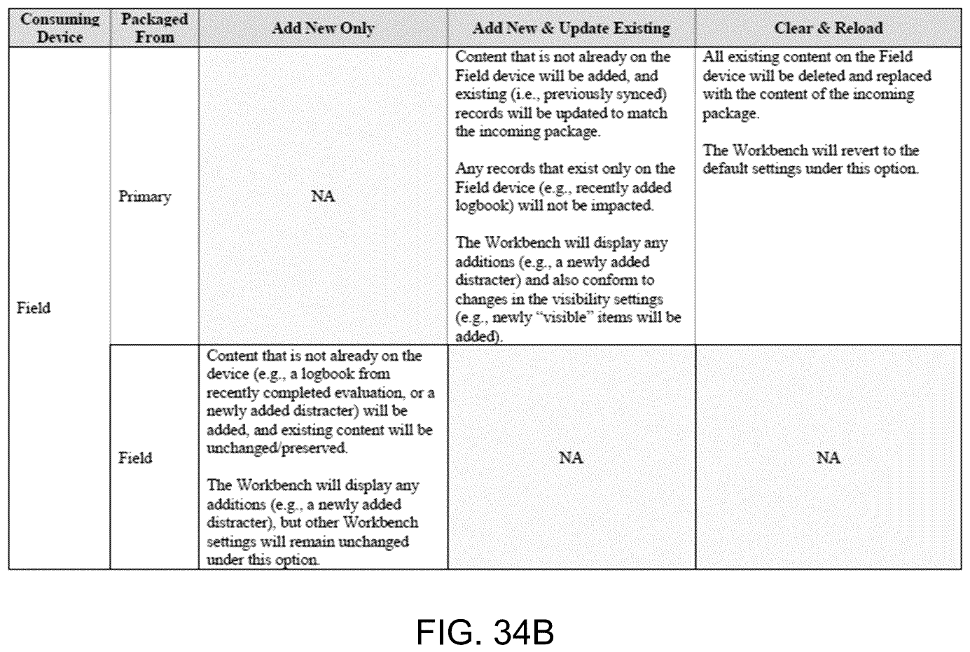

To upload some or all of an evaluation software data package from another device, one may select Consume on the Data Management page. One may locate the file to be uploaded by selecting Browse, select the file in the Windows dialog, and tap Open. This action allows the evaluation software to review the content available for consumption and to determine the package type—Primary or Field. The file name will now appear on the Data Management page and options will be presented. The user can select Consume All Content (the entire package is uploaded to the device) or Select Content to Consume (the user highlights the items to be uploaded to device). Finally, to start the upload process, the user selects an available consumption option: Add New Only, Add New & Update Existing, or Clear & Reload; which of these options are presented to the user will be dependent on the designation of both the packaging and consuming device. FIGS. 34A and 34B show a Table that lists the possible device-dependent data consumption options and examples. Once an option is selected, a popup will report the upload status, and eventually ask the user to restart the application (to reflect the new locked status of the logbooks/information).

### 2.7. Building Exercises and Assigning Run Order to Reduce/Eliminate Potential Human Bias

To eliminate or at least reduce potential human bias, the evaluation software employs randomized designs for running the exercises and recording the performance results.

### 2.7.1. Random Class

The .NET Random class represents a pseudo-random number generator, which is an algorithm that produces a sequence of numbers that meet certain statistical requirements for randomness. The Random class can be used to create a random number generator (RNG) to generate random numbers within different ranges.

As applied to the unbiased evaluation of detection performance of the evaluation software, the .NET Random class is used to create an instance of RNG (Random Number Generator) which is used to design randomized detection exercises within a defined set of bounds. For instance, a randomized detection exercise has at least one of a randomized scent lineup or a randomized detection scenario in which one or more design parameters are random number generator sampled parameters to generate the at least one of the randomized scent lineup or the randomized detection scenario. RNG samples values from user defined lists of discrete options and numerical ranges, which are first established in the App Configuration of the evaluation software and then down selected by the user in the Workbench. A sample listing of RNG sampled parameters or random number generator sampled parameters is provided below. At any time, a user can edit the parameter value ranges (e.g., hide height min/max for aircraft overhead bin) and add/remove options from the lists (e.g., search areas).
Lists of Target items.
List of Distracter items.
List of Control items.
Target probability that a target will be included in an exercise (independent values set for lineups and scenarios).
Min/Max number of targets to place in an exercise.
Min/Max number of distracters to place in an exercise.
Min/Max number of controls to place in an exercise.
List of possible search areas (one area is selected by RNG per scenario).
List of possible hide locations (one location is selected by RNG per item).
Hide height/depth range for each hide location.
Hide location weight (skews the likelihood of a particular location being sampled); e.g., Loc A with a weight of 2 is two times as likely to be sampled than Loc B with a weight of 1.
Min/Max planned set duration (how long, in minutes, items are placed before running a scenario).

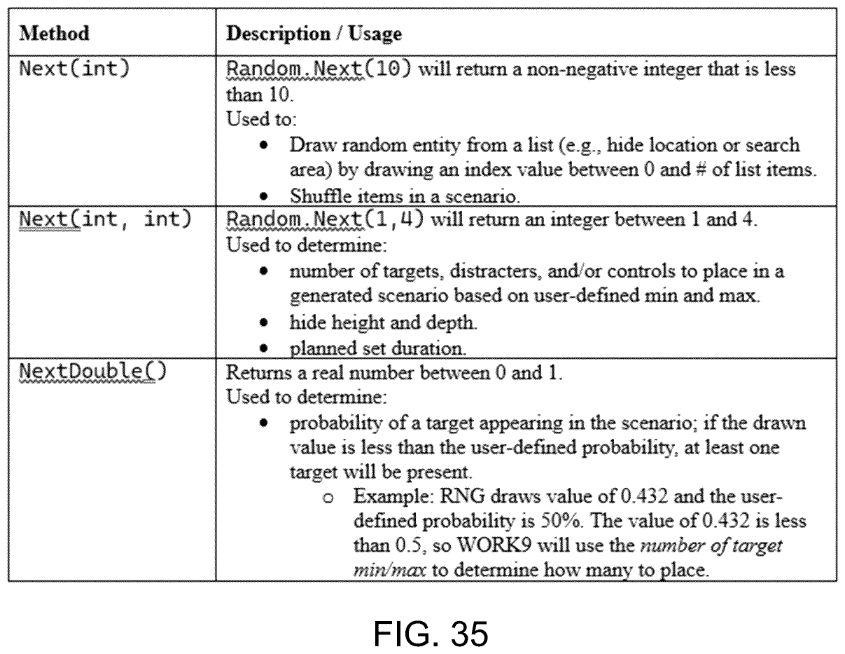

FIG. 35 shows a Table listing the methods offered by the Random class used by the evaluation software to generate random numbers and how they are used.

Under the Next(int) method, for instance, Random.Next(10) will return a non-negative integer that is less than 10. It can be used to draw random entity from a list (e.g., hide location or search area) by drawing an index value between 0 and # of list items. It can also be used to shuffle items in a scenario, for example.

Under the Next(int,int) method, for instance, Random.Next(1,4) will return an integer between 1 and 4. It can be used to determine the number of targets, distracters, and/or controls to place in a generated scenario based on user-defined or preset minimum and maximum values. It can also be used to determine the hide height and depth, planned set duration, etc.

Under the NextDouble( ) method, the Random Class method returns a real number between 0 and 1. It can be used to determine the probability of a target appearing in the scenario. If the drawn value is less than the user-defined probability, at least one target will be present. For example, the RNG draws value of 0.432 and the user-defined probability is 50%. Because the value of 0.432 is less than 0.5, the evaluation software will use the number of target min/max to determine how many targets to place.

### 2.7.2. Auto-Generating Lineups

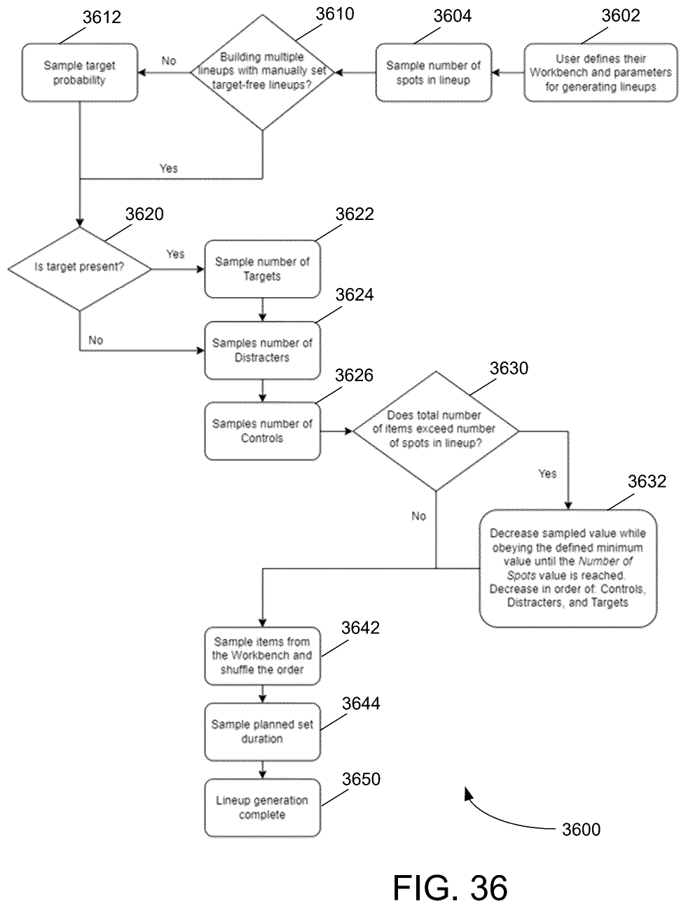

FIG. 36 is a flow diagram 3600 illustrating an example of using a RNG for auto-generating lineups in the evaluation software, as mentioned above in Section 2.4.2.1. In step 3602, the user defines the Workbench and parameters for generating lineups in the evaluation software. In step 3604, the evaluation software samples the number of spots in the lineup.

Step 3610 involves an inquiry, in the evaluation software, as to whether it is building multiple lineups with manually set target-free scent lineups. If no, the evaluation software samples the target probability in step 3612. If yes, the evaluation software skips step 3612, and the next step 3620 is to determine whether a target is present. If yes, the evaluation software samples the number of targets in step 3622. If no, the evaluation software skips step 3622, and the next step 3624 is to sample the number of distracters. In step 3626, the evaluation software samples the number of controls. The number of targets (step 3622), the number of distracters (step 3624), and the number of controls (step 3626) yields a total number of items in the lineup.

Step 3630 involves an inquiry, in the evaluation software, as to whether the total number of items exceeds the number of spots in the lineup. If yes, in step 3632, the evaluation software decreases the sampled value while obeying the defined or preset minimum value until the Number of Spots value is reached, and decreases the controls, distracters, and targets in that order. If no, the evaluation software skips step 3632.

Next, the evaluation software samples the items from the Workbench and shuffles the order in step 3642 and samples the planned set duration in step 3644. The lineup generation is complete (step 3650).

Moreover, as discussed in Section 2.4.2.1 above, the duplicate and shuffle action randomly shuffles items in the duplicated lineup to a different order. The RNG can be used for the random shuffling.

From the Build Exercises page in the evaluation software, a user has the option to auto-generate a single scent lineup or multiple scent lineups (see Section 2.4.2.1). The number of lineups to build when generating multiple is determined by the user-defined parameter value from the Workbench page (see FIG. 14; see also FIGS. 16 and 18-21). Whether or not the evaluation software is building one or multiple lineups, the process shown in FIG. 36 remains the same. However, there are two settings from the Workbench that are uniquely used when building multiple lineups: (1) repeat each target material before repeating, and (2) repeat each spot before repeating. If these are enabled and a user generates multiple lineups, the evaluation software will adjust the sampling lists of both the target items and the spots accordingly to ensure that each target material and/or each spot are used before allowing them to be sampled a second time. Another setting unique to building multiple lineups is the Number of target-free exercises. If this setting is set to “Random,” the evaluation software uses the defined probability of target parameter to determine whether a target is present, just as it does when a single exercise is built. If the setting is set to “Manually Set”, then the probability of target parameter is ignored, and a number is sampled based on the user-defined number of target-free exercises.

### 2.7.3. Auto-Generating Scenarios

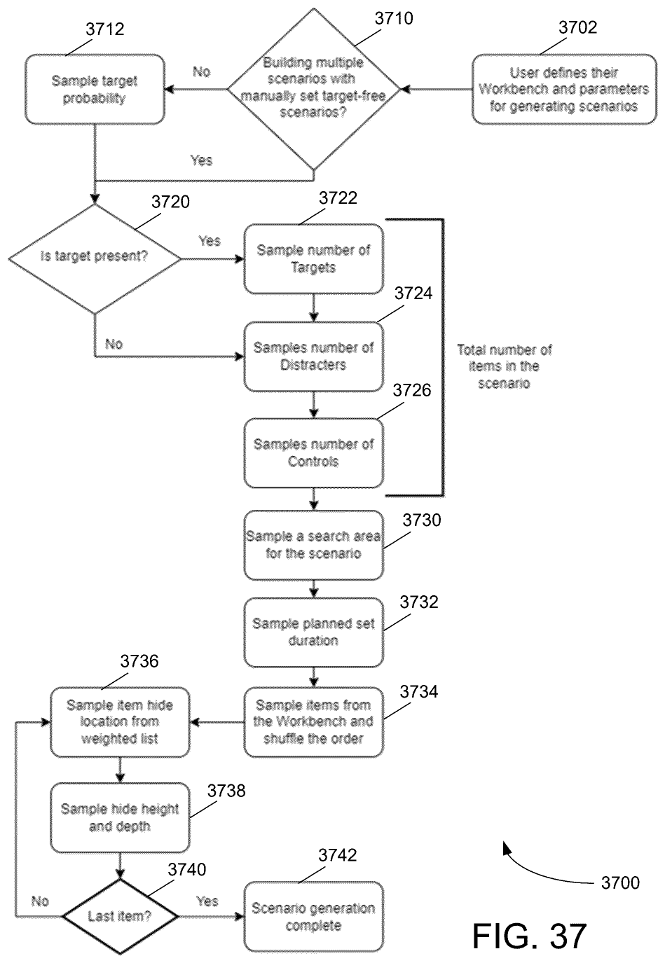

FIG. 37 is a flow diagram 3700 illustrating an example of using a RNG for auto-generating scenarios in the evaluation software, as mentioned above in Section 2.4.2.2. In step 3702, the user defines the Workbench and parameters for generating scenarios in the evaluation software.

Step 3710 involves an inquiry, in the evaluation software, as to whether it is building multiple scenarios with manually set target-free detection scenarios. If no, the evaluation software samples the target probability in step 3712. If yes, the evaluation software skips step 3712, and the next step 3720 is to determine whether a target is present. If yes, the evaluation software samples the number of targets in step 3722. If no, the evaluation software skips step 3722. It samples the number of distracters in step 3724 and samples the number of controls in step 3726. The number of targets (step 3722), the number of distracters (step 3724), and the number of controls (step 3726) yields a total number of items in the scenario.

Next, the evaluation software samples a search area for the scenario (step 3730), samples the planned set duration (step 3732), samples the items from the Workbench and shuffles the order (step 3734), samples the item hide location from a weighted list of location weights (step 3736), and samples the hide height and depth (step 3738).

Step 3740 involves an inquiry, in the evaluation software, as to whether the last item has been processed. If yes, the scenario generation is complete (step 3742). If no, the evaluation software repeats step 3734 of sampling the item hide location from the weighted list (step 3736), and samples the hide height and depth (step 3738), until the last item has been processed and the scenario generation is complete (step 3742).

Moreover, as discussed in Section 2.4.2.2 above, the duplicate and shuffle action randomly shuffles items in the duplicated scenario to a different order. The RNG can be used for the random shuffling.

From the Build Exercises page in the evaluation software, a user has the option to auto-generate a single scenario or multiple scenarios (see Section 2.4.2.2). The number of scenarios to build when generating multiple is determined by the user-defined parameter value from the Workbench page (see FIG. 14; see also FIGS. 17 and 22). Whether or not the evaluation software is building one or multiple scenarios, the process shown in FIG. 37 remains the same. However, there are two settings from the Workbench that are uniquely used when building multiple scenarios: (1) repeat each target material before repeating, and (2) repeat each search area before repeating. If these are enabled and a user generates multiple scenarios, the evaluation software will adjust the sampling lists of both the target items and the search areas accordingly to ensure that each target material and/or each search area are used before allowing them to be sampled a second time. Another setting unique to building multiple scenarios is the Number of target-free exercises. If this setting is set to “Random,” the evaluation software uses the defined probability of target parameter to determine whether a target is present, just as it does when a single exercise is built. If the setting is set to “Manually Set”, then the probability of target parameter is ignored, and a number is sampled based on the user-defined number of target-free exercises.

The method involves sampling a plurality of variable parameters such as the number of spots in a randomized scent lineup, the number of targets, the number of distracters, the number of controls, the items (i.e., targets, distracters, controls, etc.), the planned set duration, the target probability, the search area, the item hide location, the item hide height, the item hide depth, etc. Sampling variable parameters in a study involves selecting a subset of data points from a larger population or group to estimate the characteristics of that population or group. The process is crucial for making inference about the entire population based on a manageable sample size. In a randomized exercise, sampling is critical for ensuring the results of the study are valid and can be generalized to the broader population being studied. In simple probability or random sampling, each member of the population has a known, non-zero chance of being selected for the sample. By significantly reducing the time, effort, and resources required for data collection, sampling plays an important role in the cost-effectiveness and feasibility of a study.

### 2.7.4. Auto-Generating Run Order

In addition to generating a set of scenarios, the user of the evaluation software can also define the teams (handler and canine) that will perform the exercises. While team assignments are not random in the evaluation software, the user does have the option to randomly assign the order in which teams run an exercise. For this process, the evaluation software creates a list of integers from 1 to the number of teams. Then, the RNG is used to shuffle the list and assign a run order to each team.

### 3. Quality Assurance

As described in this section, quality assurance (QA) efforts spanned different tactics and multiple types of testing to ensure that the evaluation software is stable, efficient, accurate, and faithful to user requests and settings. Any issues or bugs that were discovered were prioritized for resolution by analyzing relevant error logs and any collected details (e.g., steps to reproduce an error).

### 3.1. Development Testing

During code development, any changes to the evaluation software's code underwent checks/testing before the change was considered complete to help catch issues and bugs preemptively, while their overall impact was lower.

### 3.1.1. Unit Testing

Changes to the service and data layers of code underwent unit tests, which were created and executed while the changes were still being programmed. These tests were run as new code was merged with existing code to help ensure new features did not introduce bugs or affect existing code in unexpected ways. Unit tests are technical in nature, and exercise code logic at a low level; they are not considered functional tests, but rather they confirm the correct operation of the smallest testable parts of the application (units) independently.

### 3.1.2. Peer Review

After the developer completed code changes that passed unit tests, a Pull Request (PR) was submitted. The changes were then reviewed by other developers who were not involved in the code change. These reviewers offered suggestions to improve syntax, logic, or implementation details, and requested further changes before the PR was approved. Such a gate ensured that new code changes met coding standards, had more efficient implementation, and were more maintainable. Once the PR was approved, the code was promoted into the main branch for the next release and moved to the next step of development/testing.

### 3.1.3. Quality Assurance Testing

Quality assurance tests executed by the development team were functional or technical in nature and were executed against new features or increments of features during the development process. This level of testing was completed by a different member of the team from the developer responsible for the code change, ensuring the feature was tested from at least one additional perspective. The new team member performed these tests on the application and/or functions from the user's point of view, attempting to validate the new functionality while also testing boundary conditions and likely points of failure within the feature.

### 3.2. Regression Testing

Regression tests verified that the evaluation software's features did not adversely affect existing functionality and covered a wide range of features within the application, such as tests of general function as well as more detailed or technical areas. Performing regression testing verified the functionality of core features (e.g., App Configuration, Logbooks, Canines & Handlers, Data Collection), as well as more technical functions (e.g., Data Extraction, Data Management), especially when paired with functional testing. Regression tests were maintained as new features were added and as existing tests were executed so that tests were kept current. Additionally, if an issue was discovered through other QA means, and it was determined to be a high risk of causing future bugs, it was added to the regression suite for future testing cycles.

Also, within this category of QA, performance analysis and load testing were performed to further evaluate the application and gauge how much load could be applied and how it could affect user experience (e.g., long wait times). These tests were performed on Surface Pro 6 and Surface Go devices. Listed below are several such test scenarios administered:

Bulk Loading: The concept here was to overload core tables in the database with randomly generated data. Each table was saturated with hypothetically limitless amounts of data and relationships to gain insight as to how the device reacts to rendering a vast amount of data per interface. The load increments tested were 100, 250, 500, and 1000. To illustrate one of these, the ‘100-load increment test’ entailed generating 100 logbooks, 100 exercises (spread randomly across all logbooks), 100 materials (˜33% targets, ˜33% distracters, ˜33% controls), 100 barriers, 100 demographics (50/50 canine and handlers), 100 canines, 100 trainers, etc., and then navigating around the app to see how it responded.

Production-Like Usage: This test was intended to simulate a realistic load into core database tables with randomly generated data. As an example, the team generated 5 logbooks, 600 exercises (˜120 per logbook) with ˜20 spots per exercise, 75 materials (˜33% targets, ˜33% distracters, ˜33% controls), 25 barriers, 10 demographics (50/50 canine and handlers), 10 canines, 10 trainers, etc. Then, hypothetical data was generated for one team for each of the 600 exercises. Again, the user then navigated around the app to see how it responded in search of problems and/or opportunities for improvement.

In total, the evaluation software underwent a regression suite of nearly 250 documented tests.

### 3.3. User Acceptance Testing

Less structured and less formal than the other means of QA, User Acceptance Testing (UAT) started closer to the end of the development cycle and was conducted by staff that were not part of the code development team but were nonetheless knowledgeable in the intended functionality and realistic use cases/situations. For UAT, the evaluation software was used extensively in mock-but-realistic and diverse manners by a select subset (˜four) of individuals. Errors, crashes, improper functionality, missing features, and non-ideal user experiences are all examples of UAT findings reported to the development team. As such, this form of testing was crucial for confirming the quality and usability of the application in the hands of the eventual end-users. It is estimated that a total of 400-man hours were spent on UAT.

### 4. Computer System

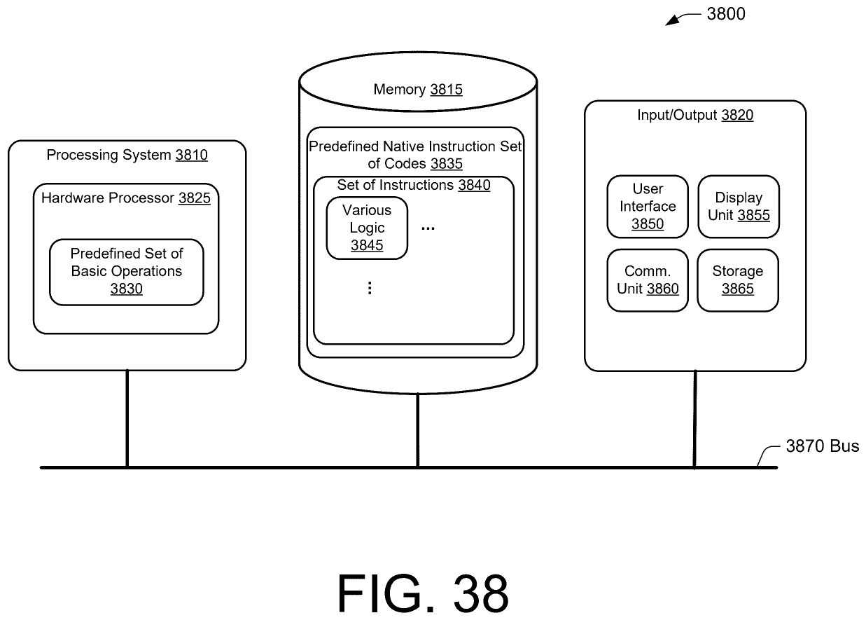

FIG. 38 illustrates a computing system 3800 including logic according to an embodiment. The computing system 3800 includes a processing system 3810 having a hardware processor 3825 configured to perform a predefined set of basic operations 3830 by loading corresponding ones of a predefined native instruction set of codes 3835 as stored in the memory 3815. The computing system 3800 further includes input/output 3820 having user interface 3850, display unit 3855, communication unit 3860, and storage 3865.

The memory 3815 is accessible to the processing system 3810 via the bus 3870. The memory 3815 includes the predefined native instruction set of codes 3835, which constitute a set of instructions 3840 selectable for execution by the hardware processor 3825. In an embodiment, the set of instructions 3840 include logic 3845 representing various processor logic and/or modules. An example of such logic 3845 is set forth in greater detail with respect to the flow diagrams illustrated in FIGS. 36 and 37. Each of the above-mentioned algorithms can be a separate system or a module in an overall computer system 3800. The various logic 3845 is stored in the memory 3815 and comprises instructions 3840 selected from the predefined native instruction set of codes 3835 of the hardware processor 3825, adapted to operate with the processing system 3810 to implement the process or processes of the corresponding logic 3845.

A hardware processor may be thought of as a complex electrical circuit that is configured to perform a predefined set of basic operations in response to receiving a corresponding basic instruction selected from a predefined native instruction set of codes. The predefined native instruction set of codes is specific to the hardware processor; the design of the processor defines the collection of basic instructions to which the processor will respond, and this collection forms the predefined native instruction set of codes. A basic instruction may be represented numerically as a series of binary values, in which case it may be referred to as a machine code. The series of binary values may be represented electrically, as inputs to the hardware processor, via electrical connections, using voltages that represent either a binary zero or a binary one. These voltages are interpreted as such by the hardware processor. Executable program code may therefore be understood to be a set of machine codes selected from the predefined native instruction set of codes. A given set of machine codes may be understood, generally, to constitute a module. A set of one or more modules may be understood to constitute an application program or “app.” An app may interact with the hardware processor directly or indirectly via an operating system. An app may be part of an operating system.

A computer program product is an article of manufacture that has a computer-readable medium with executable program code that is adapted to enable a processing system to perform various operations and actions. Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit. The following forms of storage exemplify non-transitory computer-readable media: removable storage such as a USB disk, a USB stick, a flash disk, a flash drive, a thumb drive, an external SSD, a compact flash card, an SD card, a diskette, a tape, a compact disc, an optical disc; secondary storage such as an internal hard drive, an internal SSD, internal flash memory, internal non-volatile memory, internal DRAM, ROM, RAM, and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

What is claimed is:

1. A method for building a canine detection exercise to evaluate detection performance of detecting targets by canine teams each including a dog and a handler, the method comprising:
receiving an exercise design and design parameters for generating at least one of a scent lineup or a detection scenario of the canine detection exercise; and
generating at least one scent lineup or at least one detection scenario of the canine detection exercise based on the design parameters;
the canine detection exercise having at least one of a randomized scent lineup or a randomized detection scenario in which one or more design parameters are random number generator sampled parameters to generate the at least one of the randomized scent lineup or the randomized detection scenario.

2. The method of claim 1,
wherein generating the at least one scent lineup comprises generating a randomized scent lineup; and
wherein the design parameters which can be random number generator sampled for the randomized scent lineup include a target probability of a target, a number of targets, a number of distracters, a number of controls, the targets, and a planned set duration.

3. The method of claim 2, wherein generating the randomized scent lineup comprises one or more of:
sampling a number of spots in the randomized scent lineup to be generated;
sampling the number of targets if at least one of the targets is present in the randomized scent lineup;
sampling the number of distracters;
sampling the number of controls;
if a total number of items, which equals a sum of the number of targets, the number of distracters, and the number of controls, exceeds the number of spots, decreasing a sampled value of the number of spots while obeying a preset minimum value of the number of spots until the number of spots is down to a value which is at or below the total number of items;
sampling the items, which comprises the targets, the distracters, and the controls, from the exercise design and shuffling an order of the items; or
sampling the planned set duration.

4. The method of claim 3,
wherein the sampled value of the number of spots is decreased in an order of controls, distracters, and targets.

5. The method of claim 2, wherein the method comprises generating multiple scent lineups including one or more manually set target-free scent lineups, the method further comprising:
sampling the target probability.

6. The method of claim 1,
wherein generating the at least one detection scenario comprises generating a randomized detection scenario;
wherein the design parameters which can be random number generator sampled for a randomized detection scenario include a target probability of a target, a number of the targets, a number of distracters, a number of controls, the targets, a planned set duration, a search area, an item hide location of an item of a plurality of items from a weighted list of location weights, an item hide height of the item, and an item hide depth of the item; and
wherein the plurality of items comprise the targets, the distracters, and the controls.

7. The method of claim 6, wherein generating the randomized detection scenario comprises one or more of:
sampling the number of targets in the randomized detection scenario to be generated if at least one of the targets is present in the randomized detection scenario;
sampling the number of distracters;
sampling the number of controls;
sampling the search area for the randomized detection scenario;
sampling the planned set duration;
sampling the plurality of items, which comprise the targets, the distracters, and the controls, from the exercise design and shuffling an order of the items; or
sampling the item hide location of each of the items from the weighted list of location weights until all the items from the weighted list of location weights have their item hide locations sampled.

8. The method of claim 7, further comprising:
sampling the item hide height and the item hide depth of each of the items until all the items from the weighted list of location weights have their item hide locations sampled.

9. The method of claim 6, wherein the method comprises generating multiple detection scenarios including one or more manually set target-free detection scenarios, the method further comprising:
sampling the target probability.

10. A method of evaluating detection performance of detecting targets by the canine teams according to claim 1, the method comprising:
listing the at least one scent lineup or at least one detection scenario of the canine detection exercise for the canine teams to perform detection of the targets according to the at least one scent lineup or at least one detection scenario of the canine detection exercise;
recording performance results of the canine detection exercise by the canine teams; and
storing the performance results without human manipulation and without human interference of the performance results.

11. A non-transitory computer-readable recording medium storing a program including instructions that cause a processor to execute a process for building a canine detection exercise to evaluate detection performance of detecting targets by canine teams each including a dog and a handler, comprising:
receiving an exercise design and design parameters for generating at least one of a scent lineup or a detection scenario of the canine detection exercise; and
generating at least one scent lineup or at least one detection scenario of the canine detection exercise based on the design parameters;
the canine detection exercise having at least one of a randomized scent lineup or a randomized detection scenario in which one or more design parameters are random number generator sampled parameters to generate the at least one of the randomized scent lineup or the randomized detection scenario.

12. The non-transitory computer-readable recording medium of claim 11,
wherein generating the at least one scent lineup comprises generating a randomized scent lineup; and
wherein the design parameters which can be random number generator sampled for the randomized scent lineup include a target probability of a target, a number of targets, a number of distracters, a number of controls, the targets, and a planned set duration.

13. The non-transitory computer-readable recording medium of claim 11,
wherein generating the at least one detection scenario comprises generating a randomized detection scenario;
wherein the design parameters which can be random number generator sampled for a randomized detection scenario include a target probability of a target, a number of the targets, a number of distracters, a number of controls, the targets, a planned set duration, a search area, an item hide location of an item of a plurality of items from a weighted list of location weights, an item hide height of the item, and an item hide depth of the item; and
wherein the plurality of items comprise the targets, the distracters, and the controls.

14. The non-transitory computer-readable recording medium of claim 11, wherein the program further includes instructions that cause the processor to execute a process for evaluating detection performance of detecting targets by the canine teams, comprising:
listing the at least one scent lineup or at least one detection scenario of the canine detection exercise for the canine teams to perform detection of the targets according to the at least one scent lineup or at least one detection scenario of the canine detection exercise;
recording performance results of the canine detection exercise by the canine teams; and
storing the performance results without human manipulation and without human interference of the performance results.

15. A method of evaluating detection performance of detecting targets in a canine detection exercise by canine teams each including a dog and a handler, the method comprising:
generating at least one scent lineup or at least one detection scenario of the canine detection exercise based on design parameters of an exercise design, the canine detection exercise having at least one of a randomized scent lineup or a randomized detection scenario in which one or more design parameters are random number generator sampled parameters to generate the at least one of the randomized scent lineup or the randomized detection scenario;
listing the at least one scent lineup or at least one detection scenario of the canine detection exercise for the canine teams to perform detection of the targets according to the at least one scent lineup or at least one detection scenario of the canine detection exercise;
recording performance results of the canine detection exercise by the canine teams; and
storing the performance results without human manipulation and without human interference of the performance results.

16. The method of claim 15,
wherein generating the at least one scent lineup comprises generating a randomized scent lineup; and
wherein the design parameters which can be random number generator sampled for the randomized scent lineup include a target probability of a target, a number of targets, a number of distracters, a number of controls, the targets, and a planned set duration.

17. The method of claim 16, wherein generating the randomized scent lineup comprises one or more of:
sampling a number of spots in the randomized scent lineup to be generated;
sampling the number of targets if at least one of the targets is present in the randomized scent lineup;
sampling the number of distracters;
sampling the number of controls;
if a total number of items, which equals a sum of the number of targets, the number of distracters, and the number of controls, exceeds the number of spots, decreasing a sampled value of the number of spots while obeying a preset minimum value of the number of spots until the number of spots is down to a value which is at or below the total number of items;
sampling the items, which comprises the targets, the distracters, and the controls, from the exercise design and shuffling an order of the items; or
sampling the planned set duration.

18. The method of claim 15,
wherein generating the at least one detection scenario comprises generating a randomized detection scenario;
wherein the design parameters which can be random number generator sampled for a randomized detection scenario include a target probability of a target, a number of the targets, a number of distracters, a number of controls, the targets, a planned set duration, a search area, an item hide location of an item of a plurality of items from a weighted list of location weights, an item hide height of the item, and an item hide depth of the item; and
wherein the plurality of items comprise the targets, the distracters, and the controls.

19. The method of claim 18, wherein generating the randomized detection scenario comprises one or more of:
sampling the number of targets in the randomized detection scenario to be generated if at least one of the targets is present in the randomized detection scenario;
sampling the number of distracters;
sampling the number of controls;
sampling the search area for the randomized detection scenario;
sampling the planned set duration;
sampling the plurality of items, which comprise the targets, the distracters, and the controls, from the exercise design and shuffling an order of the items; or
sampling the item hide location of each of the items from the weighted list of location weights until all the items from the weighted list of location weights have their item hide locations sampled.

20. The method of claim 18, wherein the method comprises generating multiple detection scenarios including one or more manually set target-free detection scenarios, the method further comprising:
sampling the target probability.
